(19) United States
(12) Patent Application Publication
(10) Pub. No.: US 2019/0203714 A1
(43) Pub. Date: Jul. 4, 2019

(54) ROTARY CYLINDER TYPE COMPRESSOR

(71) Applicant: DENSO CORPORATION, Kariya-city, Aichi-pref (JP)

(72) Inventors: Yuichi OHNO, Nishio-city (JP); Mikio MATSUDA, Nishio-city (JP); Hiroshi OGAWA, Nishio-city (JP); Yoshinori MURASE, Kariya-city (JP)

(21) Appl. No.: 16/084,062

(22) PCT Filed: Mar. 10, 2017
(86) PCT No.: PCT/JP2017/009771

§ 371 Date: Sep. 11, 2018

(30) Foreign Application Priority Data
Apr. 28, 2016 (JP) 2016-090780

(51) Int. Cl. F04C 18/344; F04C 23/00

(52) U.S. Cl. CPC F04C 18/3441; F05B 2240/20; F04C 2240/20; F04C 23/003

(57) ABSTRACT

A rotary cylinder type compressor includes: a cylinder that is rotatably placed in an inside of a housing; a rotor that is placed in an inside of the cylinder and is rotatable about an eccentric axis that is eccentric to a rotational central axis of the cylinder; and a partition member that partitions a working chamber formed between an outer peripheral surface of the rotor and an inner peripheral surface of the cylinder into a suction space and a compression space. When a pressure of fluid in the compression space is equal to or larger than a reference pressure, a contact stress, which is exerted at an adjoining portion between the outer peripheral surface of the rotor and the inner peripheral surface of the cylinder, is increased in comparison to a case where the pressure of the fluid in the compression space is smaller than the reference pressure.

### CROSS REFERENCE TO RELATED APPLICATION

This application is based on and incorporates herein by reference Japanese Patent Application No. 2016-90780 filed on Apr. 28, 2016.

### TECHNICAL FIELD

The present disclosure relates to a rotary cylinder type compressor that rotates a cylinder, which forms a compression space for compressing fluid in an inside of the cylinder.

### BACKGROUND ART

Previously, there is known a rotary cylinder type compressor that rotates a cylinder, which forms a compression space of fluid in an inside of the cylinder, to change a volume of the compression space, so that the fluid is compressed in and is discharged from the compression space (see the patent literature 1).

This kind of rotary cylinder type compressor includes: the cylinder, which is shaped into a cylindrical tubular form; a rotor, which is shaped into a cylindrical tubular form and is placed in an inside of the cylinder; and a vane that partitions a working chamber formed between the cylinder and the rotor into a suction space of the fluid and a compression space of the fluid. Furthermore, this rotary cylinder type compressor is configured such that in a state where a rotational central axis of the cylinder and a rotational central axis of the rotor are placed eccentric to each other, the cylinder and the rotor are rotated to change the volume of the compression space.

The rotary cylinder type compressor of the patent literature 1 is configured such that the rotational central axis of the rotor is placed eccentrically relative to the rotational central axis of the cylinder to make a contact between an inner peripheral surface of the cylinder and an outer peripheral surface of the rotor at a single point.

### CITATION LIST

### Patent Literature

PATENT LITERATURE 1: JP2015-121194A

### SUMMARY OF INVENTION

The inventors of the present application have studied the prior art rotary cylinder type compressor and have found an issue that needs to be improved. Specifically, in the rotary cylinder type compressor, a pressure of the working chamber, which is formed between the cylinder and the rotor, is largely changed at the time of operating the rotary cylinder type compressor, so that some of constituent elements may be resiliently deformed to cause a change in the amount of eccentricity between the rotational central axis of the cylinder and the rotational central axis of the rotor.

Therefore, at the time of, for example, assembling the cylinder and the rotor together, even when a positional relationship between the cylinder and the rotor is set to make the contact between the inner peripheral surface of the cylinder and the outer peripheral surface of the rotor at the single point, a minute gap may be formed between the inner peripheral surface of the cylinder and the outer peripheral surface of the rotor at the time of actual operation.

In the rotary cylinder type compressor, when a size of the gap between the inner peripheral surface of the cylinder and the outer peripheral surface of the rotor is increased, the amount of leakage of the fluid from the compression space to the suction space through the gap is increased. Thus, a compression loss is increased, and the compression performance is deteriorated.

In view of the above point, it is conceivable to increase a contact stress between the inner peripheral surface of the cylinder and the outer peripheral surface of the rotor by increasing the amount of eccentricity between the rotational central axis of the cylinder and the rotational central axis of the rotor. In this way, it is possible to limit the leakage of the fluid from the compression space to the suction space.

However, when the contact stress between the inner peripheral surface of the cylinder and the outer peripheral surface of the rotor is increased, a slide loss between the inner peripheral surface of the cylinder and the outer peripheral surface of the rotor is disadvantageously increased to cause a decrease in the compression performance.

It is an objective of the present disclosure to provide a rotary cylinder type compressor that can improve compression performance of fluid.

According to one aspect of the present disclosure, a rotary cylinder type compressor includes:

a housing that forms an outer shell:

a cylinder that is shaped into a cylindrical tubular form and is rotatably placed in an inside of the housing;

a rotor that is shaped into a cylindrical tubular form and is placed in an inside of the cylinder, wherein the rotor is rotatable about an eccentric axis that is eccentric to a rotational central axis of the cylinder by a rotational drive force of the cylinder; and

a partition member that partitions a working chamber formed between an outer peripheral surface of the rotor and an inner peripheral surface of the cylinder into a suction space, which suctions fluid, and a compression space, which compresses the fluid.

The rotor is provided as one of at least one rotor in the inside of the cylinder. The rotor and the cylinder are configured such that when a pressure of the fluid in the compression space is equal to or larger than a predetermined reference pressure, a contact stress, which is exerted at an adjoining portion between the outer peripheral surface of the rotor and the inner peripheral surface of the cylinder, is increased in comparison to a case where the pressure of the fluid in the compression space is smaller than the predetermined reference pressure.

Here, the amount of leakage of the fluid from the compression space into the suction space tends to be increased when a pressure difference between the compression space and the suction space is increased. Therefore, the leakage of the fluid from the compression space to the suction space can be effectively limited by configuring such that the contact stress, which is exerted at the adjoining portion between the outer peripheral surface of the rotor and the inner peripheral surface of the cylinder, is increased when the pressure of the fluid in the compression space is increased.

In contrast, the amount of leakage of the fluid from the compression space into the suction space tends to be decreased when the pressure difference between the compression space and the suction space is decreased. In the above described structure, the contact stress, which is exerted at the adjoining portion between the outer peripheral surface of the rotor and the inner peripheral surface of the cylinder, is reduced when the pressure of the fluid in the compression space is reduced. Therefore, the slide loss can be effectively limited at the adjoining portion between the outer peripheral surface of the rotor and the inner peripheral surface of the cylinder while limiting the leakage of the fluid from the compression space to the suction space.

Thus, according to the above-described structure, the compression loss and the slide loss are effectively limited, and thereby the compression performance of the fluid at the rotary cylinder type compressor can be improved.

According to another aspect of the present disclosure, a rotary cylinder type compressor includes:

a housing that forms an outer shell:

a cylinder that is shaped into a cylindrical tubular form and is rotatably placed in an inside of the housing;

a rotor that is shaped into a cylindrical tubular form and is placed in an inside of the cylinder, wherein the rotor is rotatable about an eccentric axis that is eccentric to a rotational central axis of the cylinder by a rotational drive force of the cylinder; and

a partition member that partitions a working chamber formed between an outer peripheral surface of the rotor and an inner peripheral surface of the cylinder into a suction space, which suctions fluid, and a compression space, which compresses the fluid.

The rotor is provided as one of at least one rotor in the inside of the cylinder. The rotor and the cylinder are configured such that when a pressure of the fluid in the compression space is equal to or larger than a predetermined reference pressure, a size of a minimum gap, which is smallest among gaps formed between the outer peripheral surface of the rotor and the inner peripheral surface of the cylinder, is reduced in comparison to a case where the pressure of the fluid in the compression space is smaller than the predetermined reference pressure.

Therefore, the leakage of the fluid from the compression space to the suction space can be effectively limited by configuring such that the size of the minimum gap between the outer peripheral surface of the rotor and the inner peripheral surface of the cylinder is reduce when the pressure of the fluid in the compression space is increased.

Furthermore, in the above-described structure, when the pressure of the fluid in the compression space is reduced, the size of the minimum gap between the outer peripheral surface of the rotor and the inner peripheral surface of the cylinder is increased, and thereby the outer peripheral surface of the rotor and the inner peripheral surface of the cylinder will be less likely to contact with each other. Thus, the slide loss at the adjoining portion between the outer peripheral surface of the rotor and the inner peripheral surface of the cylinder can be effectively limited.

Thus, according to the above-described structure, the compression loss and the slide loss are effectively limited, and thereby the compression performance of the fluid at the rotary cylinder type compressor can be improved.

### BRIEF DESCRIPTION OF DRAWINGS

FIG. 1 is an axial cross-sectional view of a compressor according to a first embodiment.

FIG. 2 is a cross-sectional view taken along line II-II in FIG. 1.

FIG. 3 is a cross-sectional view taken along line III-Ill in FIG. 1.

FIG. 4 is an exploded perspective view of a compression mechanism of the first embodiment.

FIG. 5 is a descriptive diagram for describing an operation of the compressor of the first embodiment.

FIG. 6 is a descriptive diagram for describing refrigerant leakage from a compression space to a suction space.

FIG. 7 is an axial cross-sectional view of a rotor of the first embodiment.

FIG. 8 is an axial cross-sectional view of the compression mechanism of the first embodiment.

FIG. 9 is a descriptive diagram for describing a change in a contact stress exerted at an adjoining portion of the compression mechanism of the first embodiment.

FIG. 10 is an axial cross-sectional view of the compression mechanism of a modification of the first embodiment.

FIG. 11 is a descriptive diagram for describing a change in a size of a minimum gap at the compression mechanism of the modification of the first embodiment.

FIG. 12 is an axial cross-sectional view of a cylinder of a second embodiment.

FIG. 13 is an axial cross-sectional view of the compressor of the second embodiment.

FIG. 14 is an axial cross-sectional view of the compression mechanism of a modification of the second embodiment.

FIG. 15 is an axial cross-sectional view of a rotor of a third embodiment.

FIG. 16 is a cross-sectional view taken along a line XVI-XVI in FIG. 15.

FIG. 17 is an axial cross-sectional view of the compression mechanism of the third embodiment.

FIG. 18 is a descriptive diagram for describing a change in a contact stress exerted at an adjoining portion of the compression mechanism of the third embodiment.

FIG. 19 is an axial cross-sectional view of a compression mechanism of a modification of the third embodiment.

FIG. 20 is a descriptive diagram for describing a change in a size of a minimum gap at the compression mechanism of the modification of the third embodiment.

FIG. 21 is an axial cross-sectional view of a cylinder of a fourth embodiment.

FIG. 22 is a cross-sectional view taken along line XXII-XXII in FIG. 21.

FIG. 23 is an axial cross-sectional view of the compression mechanism of the fourth embodiment.

FIG. 24 is an axial cross-sectional view of a compression mechanism according to a modification of the fourth embodiment.

### DESCRIPTION OF EMBODIMENTS

Hereinafter, embodiments of the present disclosure will be described with reference to the drawings. In the following embodiments, parts, which are the same as or equivalent to those described in the preceding embodiment(s), will be indicated by the same reference signs, and the description thereof may be omitted. Also, in the following embodiments, when only some of the constituent elements are described, corresponding constituent elements of a previously described one or more of the embodiments may be applied to the rest of the constituent elements. The following embodiments may be partially combined with each other even if such a combination is not explicitly described as long as there is no disadvantage with respect to such a combination.

### First Embodiment

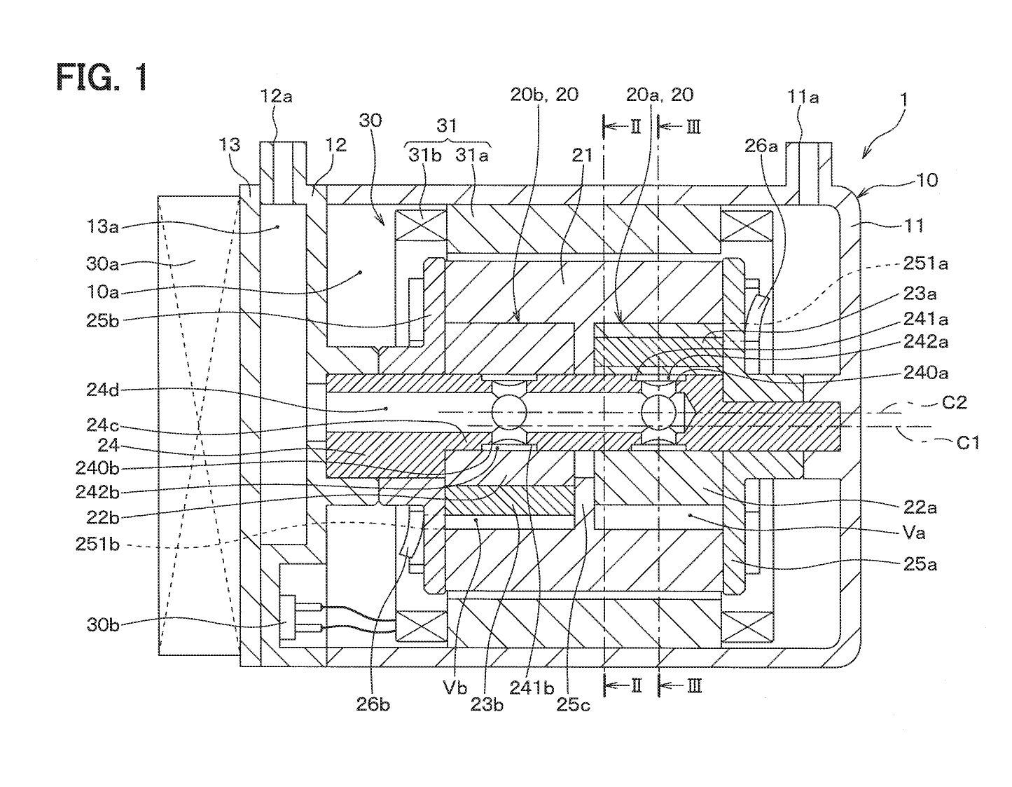

Hereinafter, the present embodiment will be described with reference to FIGS. 1 to 9. In the present embodiment, there will be described an example, in which a rotary cylinder type compressor 1 is applied to a vapor compression type refrigeration cycle that cools air to be blown into a cabin of a vehicle by a vehicle air conditioning apparatus. Hereinafter, the rotary cylinder type compressor 1 may be simply referred to as a compressor 1.

The compressor 1 has a function of compressing and discharging the refrigerant of the refrigeration cycle. In the present embodiment, the refrigerant of the refrigeration cycle serves as compression-subject fluid. In the refrigeration cycle of the present embodiment, HFC refrigerant (e.g., R134a) is used as the refrigerant. Furthermore, refrigerating machine oil, which is lubricant oil for lubricating slidable parts of the compressor 1, is mixed into the refrigerant. A portion of the refrigerating machine oil is circulated together with the refrigerant in the cycle.

Hereinafter, a basic structure and a basic operation of the compressor 1 will be described, and thereafter a characteristic structure of the compressor 1 of the present embodiment will be described. As shown in FIG. 1, the compressor 1 is formed as an electric compressor that includes a compression mechanism 20 and an electric motor 30, which are received in an inside of a housing 10 that forms an outer shell of the compressor 1. The compression mechanism 20 compresses and discharges the refrigerant, and the electric motor 30 drives the compression mechanism 20.

The housing 10 of the present embodiment is formed by combining a plurality of metal members. The housing 10 of the present embodiment has a sealed container structure that forms a generally cylindrical space in an inside of the housing 10.

Specifically, the housing 10 includes: a main housing 11, which is shaped into a bottomed cylindrical tubular form (i.e., a cup form); a sub-housing 12, which is shaped into a bottomed cylindrical tubular form and is placed to close an opening portion of the main housing 11; and a cover member 13, which is shaped into a circular plate form and is placed to close an opening portion of the sub-housing 12. The housing 10 is formed to have the sealed container structure by combining the main housing 11, the sub-housing 12 and the cover member 13 together. A seal member (not shown), such as an O-ring, is interposed between each adjacent two contacting portions of the main housing 11, the sub-housing 12 and the cover member 13 to limit a refrigerant leakage from the contacting portions.

A discharge port 11a is formed at a peripheral surface of the main housing 11 to discharge the compressed refrigerant, which is compressed by the compression mechanism 20, to an outside of the housing 10. The discharge port 11a is connected to an upstream side of a condenser of the refrigeration cycle (not shown) in the flow direction of the refrigerant.

A suction port 12a is formed at a peripheral surface of the sub-housing 12 to suction the refrigerant to be compressed at the compression mechanism 20 from the outside of the housing 10. The suction port 12a is connected to a downstream side of an evaporator of the refrigeration cycle in the flow direction of the refrigerant.

A housing-side suction passage 13a is formed between the sub-housing 12 and the cover member 13 to conduct the refrigerant, which is suctioned through the suction port 12a, to a primary working chamber Va and a secondary working chamber Vb of the compression mechanism 20.

Furthermore, a drive circuit 30a, which controls an electric power to be supplied to the electric motor 30, is installed to an opposite surface (i.e., a surface exposed to the outside) of the cover member 13, which is opposite from a sub-housing 12 side surface of the cover member 13.

The electric motor 30 includes a stator 31 that is a stationary member. The stator 31 includes a stator core 31a, which is made of a metal magnetic material and is shaped into a cylindrical tubular form, and a stator coil 31b, which is wound around the stator core 31a. The stator 31 is fixed to an inner peripheral surface of the main housing 11 by means of, for example, press fitting, shrink fitting or bolting.

The stator coil 31b is connected to the drive circuit 30a through seal terminals 30b that are installed to the sub-housing 12. The seal terminals 30b are hermetic seal terminals.

The stator 31 is placed on a radially outer side of a cylinder 21 of the compression mechanism 20. When the electric power is supplied from the drive circuit 30a to the stator coil 31b through the seal terminals 30b, a rotating magnetic field, which rotates the cylinder 21 that is placed on a radially inner side of the stator 31, is generated in the electric motor 30.

The cylinder 21 is a cylindrical member that is made of a metal magnetic material. The cylinder 21 is a member that forms primary and secondary working chambers Va, Vb of the compression mechanism 20 between the cylinder 21 and a primary rotor 22a and a secondary rotor 22b, which will be described later.

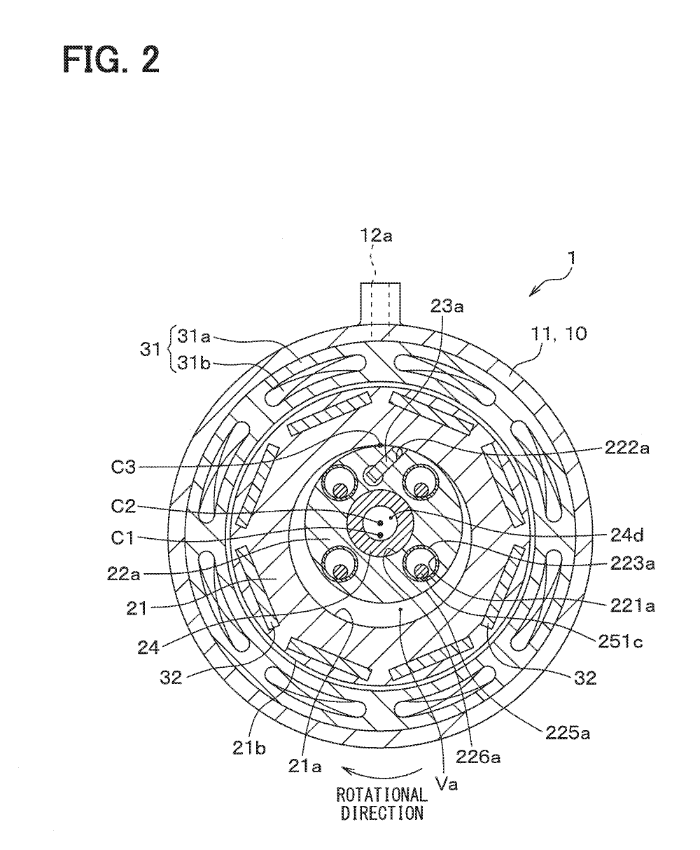

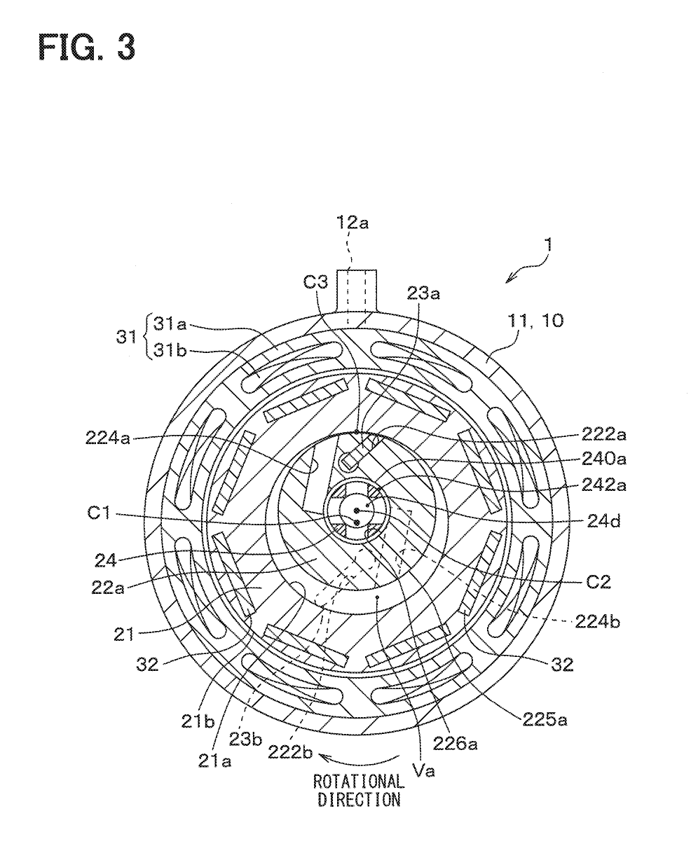

As shown in cross-sectional views of FIGS. 2 and 3, a plurality of permanent magnets 32 is fixed to the cylinder 21 such that the permanent magnets 32 are arranged one after another in a circumferential direction of the cylinder 21. Thereby, the cylinder 21 has a function of a rotating member (i.e., a rotor) of the electric motor 30. The cylinder 21 is rotated about a rotational central axis C1 by the rotating magnetic field, which is generated by the stator 31.

As described above, in the compressor 1 of the present embodiment, the rotating member (rotor) of the electric motor 30 and the cylinder 21 of the compression mechanism 20 are integrally formed as a one-piece body. Here, it should be understood that the rotating member (rotor) of the electric motor 30 and the cylinder 21 of the compression mechanism 20 may be formed by separate members, respectively, and may be integrated together by means of, for example, press fitting.

Next, the compression mechanism 20, which includes the cylinder 21 described above, will be explained. The compression mechanism 20 of the present embodiment includes a primary compression mechanism portion 20a and a secondary compression mechanism portion 20b. A basic structure of the primary compression mechanism portion 20a and a basic structure of the secondary compression mechanism portion 20b are substantially identical to each other. The primary and secondary compression mechanism portions 20a, 20b are connected in parallel with respect to a refrigerant flow in the inside of the housing 10.

Furthermore, as shown in FIG. 1, the primary and secondary compression mechanism portions 20a, 20b are arranged one after another in an axial direction of the rotational central axis C1 of the cylinder 21. In the present embodiment, one of the two compression mechanism portions, which is placed at a bottom surface side of the main housing 11, is the primary compression mechanism portion 20a, and the other one of the two compression mechanism portions, which is placed at the sub-housing 12 side, is the secondary compression mechanism portion 20b.

Furthermore, in each of the corresponding drawings, the constituent members of the secondary compression mechanism portion 20b, which correspond to equivalent constituent components of the primary compression mechanism portion 20a, will be indicated by changing a last alphabet of the corresponding reference sign from “a” to “b”. For example, among the constituent members of the secondary compression mechanism portion 20b, a secondary rotor, which is the constituent component that corresponds to a primary rotor 22a of the primary compression mechanism portion 20a, will be indicated by the reference sign “22b.”

In the compression mechanism 20, the primary compression mechanism portion 20a is formed by, for example, the cylinder 21, the primary rotor 22a, a primary vane 23a and a shaft 24, and the secondary compression mechanism portion 20b is formed by, for example, the cylinder 21, the secondary rotor 22b, a secondary vane 23b and the shaft 24.

The primary compression mechanism portion 20a and the secondary compression mechanism portion 20b of the present embodiment are formed to have the common cylinder 21 and the common shaft 24. Specifically, as shown in FIG. 1, one portion of the cylinder 21 and one portion of the shaft 24, which are located at the bottom surface side of the main housing 11, form the primary compression mechanism portion 20a, and another portion of the cylinder 21 and another portion of the shaft 24, which are located at the sub-housing 12 side, form the secondary compression mechanism portion 20b.

The cylinder 21 is a cylindrical tubular member that serves as the rotating member (rotor) of the electric motor 30 and is rotated about the rotational central axis C1, as discussed above. Furthermore, the cylinder 21 forms the primary working chamber Va of the primary compression mechanism portion 20a and the secondary working chamber Vb of the secondary compression mechanism portion 20b in the inside of the cylinder 21.

A primary side plate 25a, which closes an opening portion of the cylinder 21 that opens at one axial end of the cylinder 21, is fixed to the cylinder 21 by means of, for example, bolting. Furthermore, a secondary side plate 25b, which closes another opening portion of the cylinder 21 that opens at the other axial end of the cylinder 21, is fixed to the cylinder 21 in a manner similar to that of the primary side plate 25a. The side plates 25a, 25b respectively serve as closure members that respectively close the opening portions, which respectively open at two opposite end parts of the cylinder 21.

Each side plate 25a, 25b includes: a circular plate portion, which extends in a direction that is perpendicular to the rotational central axis C1 of the cylinder 21; and a boss portion, which is placed at a center part of the circular plate portion and projects in the axial direction. Furthermore, the boss portion of each side plate 25a, 25b includes a through-hole that extends from a front side to a back side of the circular plate portion.

A bearing mechanism (not shown) is placed in each of these through-holes, and the shaft 24 is inserted into the bearing mechanism of each through-hole. Thereby, the cylinder 21 is supported in a rotatable manner relative to the shaft 24.

An intermediate side plate 25c, which is shaped into a circular plate form, is placed in the inside of the cylinder 21 of the present embodiment. The inside of the cylinder 21 is partitioned into a primary working chamber Va and a secondary working chamber Vb by the intermediate side plate 25c, In the present embodiment, the intermediate side plate 25c is placed at generally a center part of the cylinder 21 in the axial direction.

The shaft 24 is a generally cylindrical tubular member that rotatably supports: the respective side plates 25a, 25b, 25c, which is fixed to the cylinder 21; and the respective rotors 22a, 22b, which will be described later.

Two end parts of the shaft 24 are respectively fixed to the main housing 11 and the sub-housing 12 of the housing 10. The shaft 24 does not rotate relative to the housing 10.

An eccentric portion 24c, which has an outer diameter that is smaller than an outer diameter of a sub-housing 12 side end part of the shaft 24, is formed at an axial center part of the shaft 24. A rotational central axis of the eccentric portion 24c is an eccentric axis C2 that is eccentric to the rotational central axis C1 of the cylinder 21.

The primary rotor 22a and the secondary rotor 22b are rotatably supported by the eccentric portion 24c of the shaft 24 through a bearing mechanism (not shown). In the present embodiment, an eccentric axis of the primary rotor 22a and an eccentric axis of the secondary rotor 22b are coaxially placed such that each rotor 22a, 22b rotates about the common eccentric axis C2.

As shown in FIG. 1, a shaft-side suction passage 24d is formed in the inside of the shaft 24 such that the shaft-side suction passage 24d is communicated with the housing-side suction passage 13a and conducts the refrigerant, which is supplied from the outside, to the respective working chambers Va, Vb. A plurality (e.g., four) of primary-shaft-side outlet holes 240a and a plurality (e.g., four) of secondary-shaft-side outlet holes 240b, which output the refrigerant conducted through the shaft-side suction passage 24d, are opened at an outer peripheral surface of the shaft 24. In the present embodiment, the shaft-side suction passage 24d forms a supply passage that supplies the fluid from the outside.

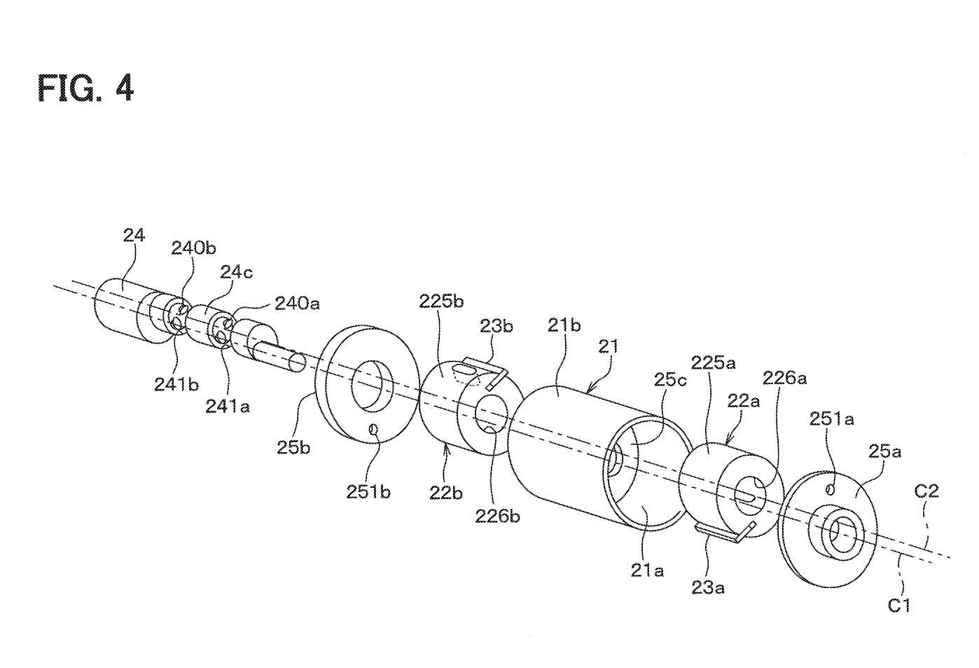

As shown in FIGS. 1 and 4, primary-shaft-side and secondary-shaft-side recesses 241a, 241b are formed at the outer peripheral surface of the shaft 24 by recessing the outer peripheral surface of the shaft 24 toward the radially inner side. The primary-shaft-side and secondary-shaft-side outlet holes 240a, 240b are opened at the primary-shaft-side and secondary-shaft-side recesses 241a, 241b, respectively.

Therefore, the primary-shaft-side and secondary-shaft-side outlet holes 240a, 240b are respectively communicated with primary-shaft-side and secondary-shaft-side communication spaces 242a, 242b, which are respectively shaped into an annular form and are formed in the primary-shaft-side and secondary-shaft-side recesses 241a, 241b, respectively.

The primary rotor 22a is a cylindrical tubular member that is placed in the inside of the cylinder 21 and extends in the axial direction of the rotational central axis C1 of the cylinder 21. The primary rotor 22a is rotatably supported by the eccentric portion 24c of the shaft 24. Therefore, the primary rotor 22a rotates about the eccentric axis C2 that is eccentric to the rotational central axis C1 of the cylinder 21.

As shown in FIG. 1, an axial length of the primary rotor 22a is substantially equal to an axial length of the one portion of the shaft 24 and of the one portion of the cylinder 21, which form the primary compression mechanism portion 20a. Furthermore, an outer diameter of the primary rotor 22a is smaller than an inner diameter of a cylindrical space formed in the inside of the cylinder 21. As shown in FIGS. 2 and 3, the outer diameter of the primary rotor 22a of the present embodiment is set such that an outer peripheral surface 225a of the primary rotor 22a and an inner peripheral surface 21a of the cylinder 21 are adjoining with each other at a single adjoining portion C3. This feature will be described later.

A drive force transmission mechanism is placed between the primary rotor 22a and the intermediate side plate 25c, and another drive force transmission mechanism is placed between the primary rotor 22a and the primary side plate 25a. The drive force transmission mechanisms transmit the rotational drive force from the cylinder 21 to the primary rotor 22a to rotate the primary rotor 22a synchronously with the cylinder 21.

The drive force transmission mechanisms of the present embodiment are respectively formed by a mechanism that is equivalent to a pin and hole type self-rotation limiting mechanism.

Specifically, as shown in FIG. 2, one of the drive force transmission mechanisms includes: a plurality of circular primary holes 221a, which are formed at an intermediate side plate 25c side surface of the primary rotor 22a; and a plurality of drive pins 251c, which project from the intermediate side plate 25c toward the primary rotor 22a. Each of the drive pins 251c has an outer diameter that is smaller than a diameter of the corresponding primary hole 221a and projects in the axial direction toward the primary rotor 22a such that the drive pin 251c is fitted into the primary hole 221a. The other, drive force transmission mechanism, which is placed between the primary rotor 22a and the primary side plate 25a, has the same configuration as that of the above described one.

With the drive force transmission mechanisms of the present embodiment, when the cylinder 21 is rotated about the rotational central axis C1, a relative position and a relative distance between each of the drive pins 251c and the eccentric portion 24c of the shaft 24 are changed. Due to the change in the relative position and the change in the relative distance, a peripheral wall surface of the primary hole 221a of the primary rotor 22a receives a load from the drive pin 251c in the rotational direction. Thereby, the primary rotor 22a is rotated about the eccentric axis C2 synchronously with the rotation of the cylinder 21. A ring member 223a, which is made of metal, is fitted into each primary hole 221a of the present embodiment to limit wearing of a peripheral wall surface of the primary hole 221a, against which the drive pin 251c contacts.

As shown in FIGS. 2 and 3, a primary groove 222a is formed at the outer peripheral surface 225a of the primary rotor 22a such that the primary rotor 22a is recessed toward the radially inner side along the entire axial extent of the outer peripheral surface 225a. The primary vane 23a, which will be described later, is slidably fitted into the primary groove 222a.

In a cross section of the primary rotor 22a that is perpendicular to the axial direction of the eccentric axis C2, the primary groove 222a is shaped into a form that extends in a direction that is tilted relative to a radial direction of the primary rotor 22a. Therefore, the primary vane 23a, which is fitted into the primary groove 222a, is displaceable in the direction that is tilted relative to the radial direction of the primary rotor 22a.

As shown in FIG. 3, a primary-rotor-side suction passage 224a extends in the primary rotor 22a such that the primary-rotor-side suction passage 224a is tilted relative to the radial direction of the primary rotor 22a, like the primary groove 222a. Furthermore, the primary-rotor-side suction passage 224a communicates between an outer peripheral surface 225a of the primary rotor 22a and an inner peripheral surface 226a of the primary rotor 22a. A fluid outlet of the primary-rotor-side suction passage 224a opens at a location that is immediately after the primary groove 222a in the rotational direction. In this way, the refrigerant, which flows from the outside into the shaft-side suction passage 24d, is conducted to the primary-rotor-side suction passage 224a.

The primary vane 23a is a partition member that is in a plate form and partitions the primary working chamber Va, which is formed between the outer peripheral surface 225a of the primary rotor 22a and the inner peripheral surface 21a of the cylinder 21, into a primary suction space Va_IN, which suctions the refrigerant, and a primary compression space Va_OUT, which compresses the refrigerant. An axial length of the primary vane 23a is substantially equal to an axial length of the primary rotor 22a. Furthermore, a radially outer end part of the primary vane 23a is slidable relative to the inner peripheral surface 21a of the cylinder 21.

Furthermore, as shown in FIG. 1, a primary discharge hole 251a, which discharges the refrigerant compressed in the primary working chamber Va to an inside space of the housing 10, is formed in the primary side plate 25a. Furthermore, a primary discharge valve 26a is installed to the primary side plate 25a. The primary discharge valve 26a opens the primary discharge hole 251a when the refrigerant pressure of the primary compression space Va_OUT of the primary working chamber Va is larger than a predetermined discharge pressure. The primary discharge valve 26a of the present embodiment is made of, for example, a reed valve that limits backflow of the refrigerant of the inside space of the housing 10 to the primary working chamber Va through the primary discharge hole 251a.

Next, the secondary compression mechanism portion 20b will be described. As discussed above, the basic structure of the secondary compression mechanism portion 20b is the same as that of the primary compression mechanism portion 20a. Therefore, as shown in FIG. 1, the secondary rotor 22b is made of a cylindrical tubular member that has an axial length, which is substantially equal to an axial length of the other portion of the shaft 24 and the other portion of the cylinder 21, which form the secondary compression mechanism portion 20b.

Furthermore, the eccentric axis C2 of the secondary rotor 22b and the eccentric axis C2 of the primary rotor 22a are coaxially placed. Therefore, similar to the primary rotor 22a, the outer peripheral surface 225b of the secondary rotor 22b and the inner peripheral surface 21a of the cylinder 21 are adjoining with each other at the adjoining portion C3 shown in FIGS. 2 and 3.

Drive force transmission mechanisms, which are similar to the drive force transmission mechanisms that transmit the rotational drive force from the cylinder 21 to the primary rotor 22a, are respectively placed at a location between the secondary rotor 22b and the intermediate side plate 25c and a location between the secondary rotor 22b and the secondary side plate 25b. Therefore, a plurality of circular secondary holes, into which a plurality of drive pins is respectively fitted, is formed at the secondary rotor 22b, Ring members, which are similar to the ring members fitted into the primary holes 221a, are respectively fitted into the secondary holes.

Furthermore, as indicated by a dotted line in FIG. 3, a secondary groove 222b is recessed toward the radially inner side along the entire axial extent of the outer peripheral surface 225b of the secondary rotor 22b. A secondary vane 23b is slidably fitted into the secondary groove 222b.

In a cross section of the secondary rotor 22b that is perpendicular to the axial direction of the eccentric axis C2, similar to the primary groove 222a, the secondary groove 222b is shaped into a form that extends in a direction that is tilted relative to a radial direction of the secondary rotor 22b.

As indicated by a dotted line in FIG. 3, a secondary-rotor-side suction passage 224b extends in the secondary rotor 22b such that the secondary-rotor-side suction passage 224b is tilted relative to the radial direction of the secondary rotor 22b, like the secondary groove 222b. Furthermore, the secondary-rotor-side suction passage 224b communicates between an outer peripheral surface 225b of the secondary rotor 22b and an inner peripheral surface 226b of the secondary rotor 22b.

The secondary vane 23b is a partition member that is in a plate form and partitions the secondary working chamber Vb, which is formed between the outer peripheral surface 225b of the secondary rotor 22b and the inner peripheral surface 21a of the cylinder 21, into a secondary suction space Vb_IN, which suctions the refrigerant, and a secondary compression space Vb_OUT, which compresses the refrigerant. An axial length of the secondary vane 23b is substantially equal to an axial length of the secondary rotor 22b. Furthermore, a radially outer end part of the secondary vane 23b is slidable relative to the inner peripheral surface 21a of the cylinder 21.

Furthermore, as shown in FIG. 1, a secondary discharge hole 251b, which discharges the refrigerant compressed in the secondary working chamber Vb to the inside space of the housing 10, is formed in the secondary side plate 25b. Furthermore, a secondary discharge valve 26b is installed to the secondary side plate 25b. The secondary discharge valve 26b opens the secondary discharge hole 251b when the refrigerant pressure of the secondary compression space Vb_OUT of the secondary working chamber Vb is larger than a predetermined discharge pressure. The secondary discharge valve 26b of the present embodiment is made of, for example, a reed valve that limits backflow of the refrigerant of the inside space of the housing 10 to the secondary working chamber Vb through the secondary discharge hole 251b.

Furthermore, at the secondary compression mechanism portion 20b of the present embodiment, as indicated by dotted lines in FIG. 3, the secondary vane 23b, the secondary-rotor-side suction passage 224b and the secondary discharge hole 251b are respectively placed at corresponding locations, which are generally 180 degrees displaced from the locations of the corresponding constituent elements of the primary compression mechanism portion 20a.

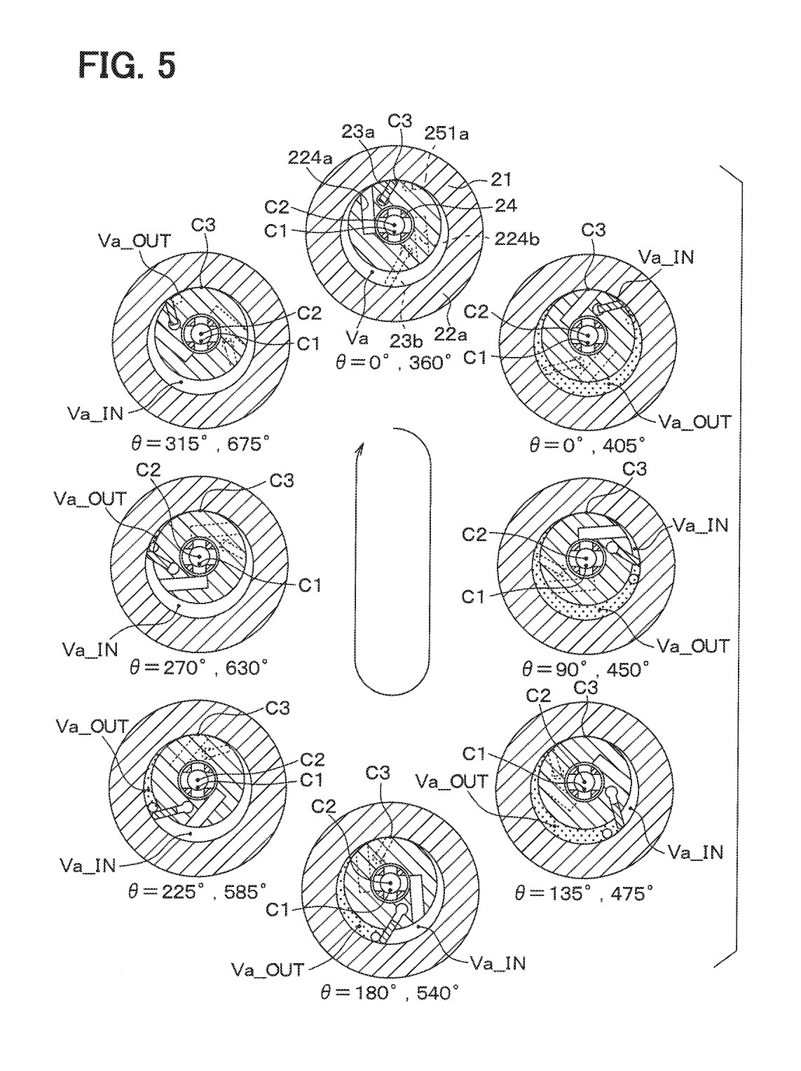

Next, a basic operation of the compressor 1 of the present embodiment will be described with reference to FIG. 5. FIG. 5 is a descriptive diagram that continuously indicates a change in the primary working chamber Va in response to the rotation of the cylinder 21 for the purpose of describing the operational states of the compressor 1. In the cross sectional views of FIG. 5, which respectively correspond to the corresponding rotational angles 8 of the cylinder 21, the location of the primary-rotor-side suction passage 224a and the location of the primary vane 23a in the cross sectional view similar to FIG. 3 are indicated by a solid line. Furthermore, in FIG. 5, the location of the secondary-rotor-side suction passage 224b and the location of the secondary vane 23b at the respective rotational angles 8 are indicated by a dotted line. Furthermore, in FIG. 5, for the sake of clarity of depiction, the reference signs of the respective constituent members are indicated only at the cross-sectional view that corresponds to 0 (zero) degrees of the rotational angle θ of the cylinder 21 (i.e., 8=0 degrees), and the indication of the reference signs of the respective constituent members is omitted at the other cross-sectional views. In FIG. 5, the rotational angle θ of the cylinder 21 is defined to be 0 degrees in a state where the adjoining portion C3 and a radially outer end part of the primary vane 23a overlap with each other.

As shown in FIG. 5, when the rotational angle θ of the cylinder 21 is 0 degrees, the primary compression space Va_OUT, which has a maximum volume, is formed on the front side of the primary vane 23a in the rotational direction, and the primary suction space Va_IN, which has a minimum volume, is formed on the rear side of the primary vane 23a in the rotational direction. Here, the primary suction space Va_IN is a space that is in a corresponding stroke, in which the volume of the primary working chamber Va is increased. Furthermore, the primary compression space Va_OUT is a space that is in a corresponding stroke, in which the volume of the primary working chamber Va is reduced.

Furthermore, when the rotational angle θ of the cylinder 21 is increased from 0 degrees, the cylinder 21, the primary rotor 22a and the primary vane 23a are displaced, so that the volume of the primary suction space Va_IN is increased, as indicated in the views of the rotational angle θ from 45 degrees to 315 degrees in FIG. 5.

In this way, the refrigerant, which is suctioned from the suction port 12a formed at the sub-housing 12, flows through the housing-side suction passage 13a, the primary-shaft-side outlet hole 240a of the shaft-side suction passage 24d, and the primary-rotor-side suction passage 224a in this order and is supplied to the primary suction space Va_IN.

At this time, a centrifugal force, which is generated in response to the rotation of the primary rotor 22a, is exerted to the primary vane 23a, so that the radially outer end part of the primary vane 23a is urged against the inner peripheral surface of the cylinder 21. Thereby, the primary working chamber Va is partitioned into the primary suction space Va_IN and the primary compression space Va_OUT by the primary vane 23a.

When the rotational angle θ of the cylinder 21 reaches 360 degrees (i.e., returns to the rotational angle θ=0 degrees), the volume of the primary suction space Va_IN reaches the maximum volume. Furthermore, when the rotational angle θ is increased from the 360 degrees, the communication between the primary suction space Va_IN and the primary-rotor-side suction passage 224a is blocked. In this way, the primary compression space Va_OUT is formed on the front side of the primary vane 23a in the rotational direction.

Furthermore, when the rotational angle θ of the cylinder 21 is increased from 360 degrees, the volume of the primary compression space Va_OUT, which is located on the front side of the primary vane 23a in the rotational direction, is reduced, as indicated by the dot hatching in the views of the rotational angle θ from 405 degrees to 675 degrees in in FIG. 5.

In this way, the refrigerant pressure in the primary compression space Va_OUT is increased. When the refrigerant pressure in the primary compression space Va_OUT reaches the discharge pressure that is equal to or larger than the refrigerant pressure in the inside space of the housing 10, the primary discharge valve 26a is opened. Thereby, the refrigerant in the primary compression space Va_OUT is discharged to the inside space of the housing 10 through the primary discharge hole 251a.

In the above description of the operation, in order to clarify the operational mode of the primary compression mechanism portion 20a, the changes at the primary working chamber Va in the range of the rotational angles 8 of the cylinder 21, which are 0 degrees to 720 degrees, have been described. However, in reality, the suction stroke of the refrigerant, which is described with respect to the time of changing the rotational angle θ of the cylinder 21 from 0 degrees to 360 degrees, and the compression stroke of the refrigerant, which is described with respect to the time of changing the rotational angle θ of the cylinder 21 from 360 degrees to 720 degrees, are simultaneously executed during one rotation of the cylinder 21.

Furthermore, the secondary compression mechanism portion 20b is operated in a manner similar to that of the primary compression mechanism portion 20a to execute the compression and suction of the refrigerant. At this time, in the secondary compression mechanism portion 20b, for example, the secondary vane 23b is phase shifted from the primary vane 23a of the primary compression mechanism portion 20a by 180 degrees. Specifically, in the present embodiment, the rotational angle θ of the cylinder 21, at which the refrigerant pressure of the secondary compression space Vb_OUT reaches the discharge pressure, is displaced by 180 degrees relative to the rotational angle θ of the cylinder 21, at which the refrigerant pressure of the primary compression space Va_OUT reaches the discharge pressure.

Therefore, in the secondary compression space Vb_OUT, the compression and the suction of the refrigerant are respectively executed at the rotational angles, which are phase shifted from those of the primary compression space Va_OUT by 180 degrees. The refrigerant, which is discharged from the secondary compression mechanism portion 20b to the inside space of the housing 10, is merged with the refrigerant, which is discharged from the primary compression mechanism portion 20a, and this merged refrigerant is discharged from the discharge port 11a of the housing 10.

In the compressor 1 of the present embodiment, each working chamber Va, Vb is partitioned into the suction space, which suctions the refrigerant, and the compression space, which compresses the refrigerant, at the adjoining portion C3 between inner peripheral surface 21a of the cylinder 21 and the outer peripheral surface 225a, 225b of the rotor 22a, 22b, which serves as a boundary between these spaces.

It is thought that the refrigerant of the primary compression space Va_OUT does not leak to the primary suction space Va_IN in a case where the outer peripheral surface 225a of the primary rotor 22a contacts the inner peripheral surface 21a of the cylinder 21 at the adjoining portion C3. Similarly, in the secondary working chamber Vb, it is thought that the refrigerant of the primary compression space Va_OUT does not leak to the primary suction space Va_IN in the case where the inner peripheral surface 21a of the cylinder 21 contacts the outer peripheral surface 225a of the primary rotor 22a at the adjoining portion C3.

Therefore, the inventors of the present application have studied the structure, in which each rotor 22a, 22b is assembled to the inside of the cylinder 21 such that the rotor 22a, 22b contacts the cylinder 21 at the adjoining portion C3.

However, when the inventors of the present application have actually operated the compressor 1 in the state where the rotor 22a, 22b contacts the cylinder 21 at the adjoining portion C3, it is found that a minute gap is generated at the adjoining portion C3.

The reason for the generation of the minute gap is as follows. Specifically, for example, the pressure in each working chamber Va, Vb largely changes at the time of operating the compressor 1, so that some (e.g., the eccentric portion 24c of the shaft 24) of the constituent elements of the compression mechanism 20 may be resiliently deformed to change the amount of eccentricity between the cylinder 21 and each rotor 22a, 22b.

As shown in FIG. 6, in the compressor 1 of the present embodiment, when the gap, which is generated at the adjoining portion C3 between the cylinder 21 and the rotor 22a, 22b, is increased, the amount of leakage of the refrigerant, which leaks from the compression space for compressing the refrigerant to the suction space for suctioning the refrigerant through the gap, is increased at the working chamber Va, Vb. The increase in the amount of leakage of the refrigerant discussed above causes an increase in the compression loss to reduce the compression performance and is thereby not desirable.

In view of the above point, it is conceivable to increase a contact stress between the inner peripheral surface 21a of the cylinder 21 and the outer peripheral surface 225a, 225b of each rotor 22a, 22b by increasing the amount of eccentricity between the rotational central axis C1 of the cylinder 21 and the eccentric portion 24c, which forms the rotational central axis of the rotor 22a, 22b.

However, when the contact stress between the cylinder 21 and each rotor 22a, 22b is increased, a slide loss between the inner peripheral surface 21a of the cylinder and the outer peripheral surface 225a, 225b of the rotor 22a, 22b is disadvantageously increased to cause a decrease in the compression performance.

The inventors of the present application have diligently studied to improve the compression performance of the compressor 1. As a result of the study, it is found that the increase in the compression loss caused by the refrigerant leakage becomes prominent when a pressure difference between the refrigerant pressure (i.e., the suction pressure of the refrigerant) of each suction space Va_IN, Vb_IN and the refrigerant pressure of corresponding compression space Va_OUT, Vb_OUT becomes large.

In view of the above point, the inventors of the present application have proposed a structure, in which the contact stress between the cylinder 21 and each rotor 22a, 22b is increased when a pressure difference between the refrigerant pressure of the corresponding suction space Va_IN, Vb_IN and the refrigerant pressure of the corresponding compression space Va_OUT, Vb_OUT is increased. Specifically, the compressor 1 of the present embodiment is configured such that when the refrigerant pressure of each compression space Va_OUT, Vb_OUT becomes equal to or larger than the predetermined reference pressure, the contact stress exerted between the cylinder 21 and the corresponding rotor 22a, 22b is increased in comparison to a case where the refrigerant pressure of the compression space Va_OUT, Vb_OUT becomes smaller than the predetermined reference pressure. The contact stress, which is exerted between the cylinder 21 and each rotor 22a, 22b, can be adjusted by measuring a rotational torque of the cylinder 21 at the time of assembling the cylinder 21 and each rotor 22a, 22b.

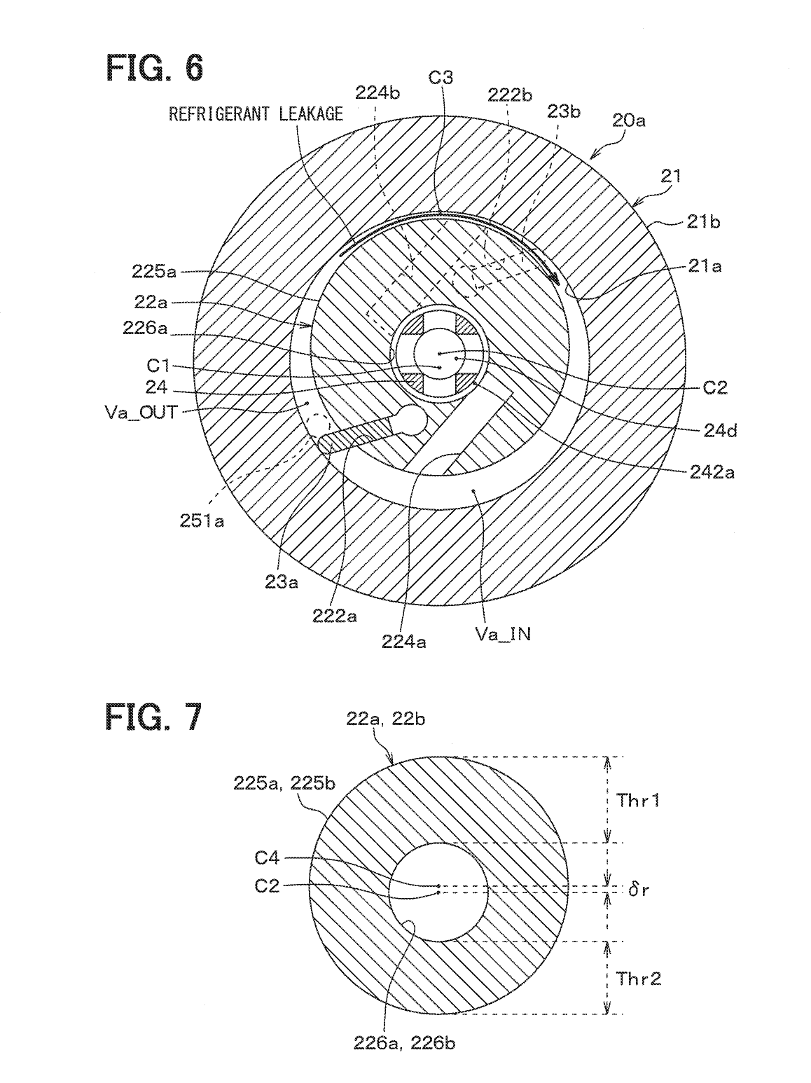

Specifically, in the present embodiment, as shown in FIG. 7, the central axis C4 of the outer peripheral surface 225a, 225b of each rotor 22a, 22b is set to be eccentric to the eccentric axis C2, which is the central axis of the inner peripheral surface 226a, 226b of each rotor 22a, 22b.

Thereby, a thickness of each rotor 22a, 22b varies in the circumferential direction of the rotor 22a, 22b. For example, a maximum value Thr1 of the thickness of each rotor 22a, 22b is set to be larger than a minimum value Thr2 of the thickness of each rotor 22a, 22b by the amount that corresponds to the amount of eccentricity or between the central axis C4 of the outer peripheral surface 225a, 225b and the eccentric axis C2.

Here, each rotor 22a, 22b of the present embodiment is configured such that a radius of a portion of the outer peripheral surface 225a, 225b, at which the thickness of the rotor 22a, 22b is maximum, is equal to or larger than a radius of the inner peripheral surface 21a of the cylinder 21. Furthermore, each rotor 22a, 22b of the present embodiment is configured such that a radius of another portion of the outer peripheral surface 225a, 225b, at which the thickness of the rotor 22a, 22b is minimum, is smaller than the radius of the inner peripheral surface 21a of the cylinder 21.

Also, each rotor 22a, 22b is configured such that the contact stress, which is exerted at the adjoining portion C3 between the cylinder 21 and the rotor 22a, 22b, is maximized in a range of rotational angle θ, throughout which the refrigerant pressure of the corresponding compression space Va_OUT, Vb_OUT is equal to or larger than the predetermined reference pressure.

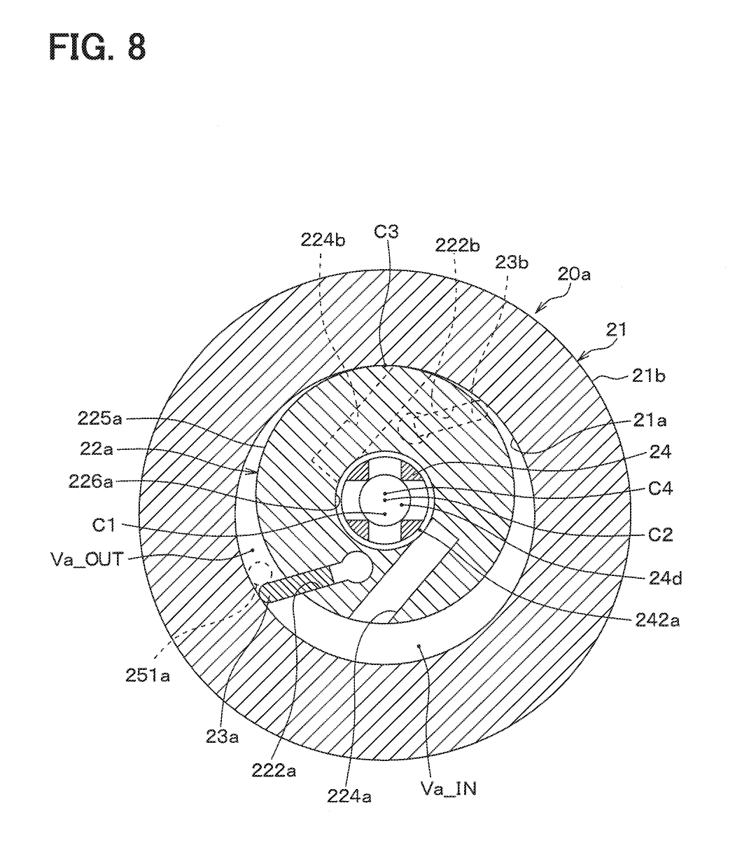

FIG. 8 shows an axial cross section of the primary compression mechanism portion 20a at the rotational angle θ (e.g., 240 degrees), at which the refrigerant pressure of the primary compression space Va_OUT reaches the discharge pressure. As shown in FIG. 8, the primary rotor 22a is configured such that the adjoining portion C3, the central axis C4 of the outer peripheral surface 225a of the primary rotor 22a, and the eccentric axis C2 are arranged one after another in this order along a straight line at the rotational angle θ, at which the refrigerant pressure of the primary compression space Va_OUT reaches the discharge pressure.

Similarly, the secondary rotor 22b is configured such that the adjoining portion C3, the central axis C4 of the outer peripheral surface 225b of the secondary rotor 22b, and the eccentric axis C2 are arranged one after another in this order along a straight line at the rotational angle θ, at which the refrigerant pressure of the secondary compression space Vb_OUT reaches the discharge pressure.

As discussed above, in the present embodiment, the rotational angle θ of the cylinder 21, at which the refrigerant pressure of the secondary compression space Via OUT reaches the discharge pressure, is displaced by 180 degrees relative to the rotational angle θ of the cylinder 21, at which the refrigerant pressure of the primary compression space Va_OUT reaches the discharge pressure.

Therefore, the secondary rotor 22b may be configured such that the adjoining portion C3, the central axis C4 and the eccentric axis C2 are arranged one after another in this order along the straight line at the rotational angle θ of the cylinder 21 that is rotated by 180 degrees from the rotational angle θ of the cylinder 21, at which the refrigerant pressure of the primary compression space Va_OUT reaches the discharge pressure.

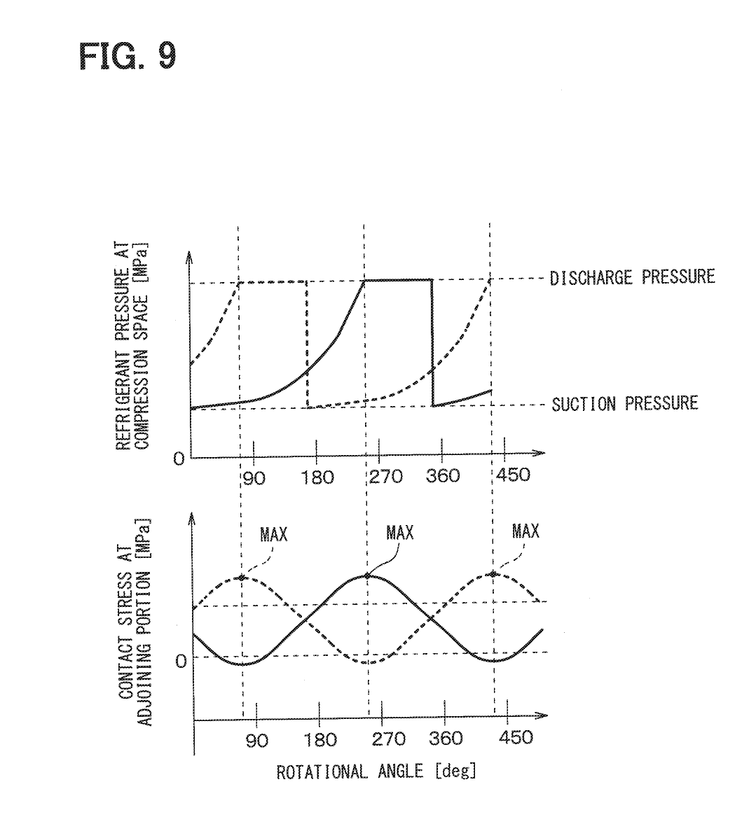

Here, FIG. 9 is a descriptive diagram for describing a change in the refrigerant pressure of the primary compression space Va_OUT and a change in the contact stress at the adjoining portion C3 at the time of changing the rotational angle θ of the cylinder 21 from 0 degrees to 360 degrees after completion of the suctioning of the refrigerant into the primary working chamber Va.

In FIG. 9, the change in the refrigerant pressure of the primary compression space Va_OUT and the change in the contact stress at the adjoining portion C3 between the cylinder 21 and the primary rotor 22a are indicated by solid lines, respectively. Furthermore, in FIG. 9, a change in the refrigerant pressure of the secondary compression space Vb_OUT and a change in the contact stress at the adjoining portion C3 between the cylinder 21 and the secondary rotor 22b are indicated by dotted lines, respectively.

As indicated by the solid line in FIG. 9, when the rotational angle θ of the cylinder 21 is increased from 0 degrees, the refrigerant pressure of the primary compression space Va_OUT is progressively increased. When the rotational angle θ of the cylinder 21 reaches around 240 degrees, the refrigerant pressure of the primary compression space Va_OUT reaches the discharge pressure. Thus, the primary discharge valve 26a is opened. Thereby, the refrigerant in the primary compression space Va_OUT is discharged to the inside space of the housing 10 through the primary discharge hole 251a.

At this time, the adjoining portion C3, the central axis C4 of the outer peripheral surface 225a of the primary rotor 22a and the eccentric axis C2 are placed one after another along the straight line, so that the radius of the outer peripheral surface 225a of the primary rotor 22a at the adjoining portion C3 becomes equal to or larger than the radius of the inner peripheral surface 21a of the cylinder 21. Specifically, in the primary compression mechanism portion 20a of the present embodiment, when the refrigerant pressure of the primary compression space Va_OUT reaches the discharge pressure, the contact stress, which is exerted at the adjoining portion C3 between the inner peripheral surface 21a of the cylinder 21 and the outer peripheral surface 225a of the primary rotor 22a, is maximized.

Here, the amount of leakage of the refrigerant from the primary compression space Va_OUT to the primary suction space Va_IN becomes prominent when the pressure difference between the primary compression space Va_OUT and the primary suction space Va_IN is maximized.

In contrast, until the refrigerant pressure of the primary compression space Va_OUT reaches the discharge pressure, the pressure difference between the primary compression space Va_OUT and the primary suction space Va_IN is small, and the amount of leakage of the refrigerant from the primary compression space Va_OUT to the primary suction space Va_IN is small.

In the primary compression mechanism portion 20a of the present embodiment, when the refrigerant pressure of the primary compression space Va_OUT reaches the discharge pressure, the contact stress between the cylinder 21 and the primary rotor 22a is maximized. Therefore, in the primary compression mechanism portion 20a of the present embodiment, the leakage of the refrigerant from the primary compression space Va_OUT to the primary suction space Va_IN can be effectively limited.

Furthermore, in the primary compression mechanism portion 20a of the present embodiment, the contact stress between the cylinder 21 and the primary rotor 22a is small until the refrigerant pressure of the primary compression space Va_OUT reaches the discharge pressure. Therefore, in the primary compression mechanism portion 20a of the present embodiment, the slide loss between the inner peripheral surface 21a of the cylinder 21 and the outer peripheral surface 225a of the primary rotor 22a can be limited while the amount of leakage of the refrigerant from the primary compression space Va_OUT to the primary suction space Va_IN is limited.

Next, as indicated by the dotted line in FIG. 9, when the rotational angle θ of the cylinder 21 reaches around 180 degrees, the suctioning of the refrigerant at the secondary working chamber Vb is completed. Then, when the rotational angle θ of the cylinder 21 is increased from 180 degrees, the refrigerant pressure of the secondary compression space Vb_OUT is progressively increased. When the rotational angle θ of the cylinder 21 reaches around 420 degrees, the refrigerant pressure of the secondary compression space Vb_OUT reaches the discharge pressure. Thereby, the secondary discharge valve 26b is opened. In this way, the refrigerant of the secondary compression space Vb_OUT is discharged to the inside space of the housing 10 through the secondary discharge hole 251b.

At this time, in the secondary compression mechanism portion 20b, when the refrigerant pressure of the secondary compression space Vb_OUT reaches the discharge pressure, the contact stress, which is exerted at the adjoining portion C3 between the inner peripheral surface 21a of the cylinder 21 and the outer peripheral surface 225b of the secondary rotor 22b, is maximized.

Therefore, in the secondary compression mechanism portion 20b of the present embodiment, the leakage of the refrigerant from the secondary compression space Vb_OUT to the secondary suction space Vb_IN can be effectively limited. Furthermore, in the secondary compression mechanism portion 20b of the present embodiment, the contact stress between the cylinder 21 and the secondary rotor 22b is small until the refrigerant pressure of the secondary compression space Vb_OUT reaches the discharge pressure. Thus, in the secondary compression mechanism portion 20b of the present embodiment, the slide loss between the inner peripheral surface 21a of the cylinder 21 and the outer peripheral surface 225b of the secondary rotor 22b can be limited while the leakage of the refrigerant from the secondary compression space Vb_OUT to the secondary suction space Vb_IN is limited.

The compressor 1 of the present embodiment can suction the refrigerant (the fluid) and discharges the refrigerant after compressing the refrigerant in the refrigeration cycle system. Particularly, the compressor 1 of the present embodiment is configured such that when the refrigerant pressure of the compression space, which compresses the refrigerant at the compression mechanism 20, becomes large, the contact stress, which is exerted at the adjoining portion C3 between the outer peripheral surface 225a, 225b of the corresponding rotor 22a, 22b and the inner peripheral surface 21a of the cylinder 21 becomes large. Thereby, the leakage of the refrigerant from the compression space Va_OUT, Vb_OUT to the suction space Va_IN, Vb_IN can be effectively limited.

Furthermore, the compressor 1 of the present embodiment is configured such that when the refrigerant pressure of the compression space, which compresses the refrigerant at the compression mechanism 20, becomes small, the contact stress, which is exerted at the adjoining portion C3 between the outer peripheral surface 225a, 225b of the corresponding rotor 22a, 22b and the inner peripheral surface 21a of the cylinder 21, becomes small. Therefore, the slide loss at the adjoining portion C3 between the outer peripheral surface 225a, 225b of each rotor 22a, 22b and the inner peripheral surface 21a of the cylinder 21 can be effectively limited while the leakage of the refrigerant from the corresponding compression space Va_OUT, Vb_OUT to the corresponding suction space Va_IN, Vb_IN is limited.

Thus, the compressor 1 of the present embodiment effectively limits the compression loss and the slide loss, so that the compression performance for compressing the refrigerant at the compression mechanism 20 can be improved.

Furthermore, according to the present embodiment, the central axis C4 of the outer peripheral surface 225a, 225b of each rotor 22a, 22b is placed eccentrically to the eccentric axis C2 that serves as the central axis of the inner peripheral surface 226a, 226b of the rotor 22a, 22b. In this way, the contact stress, which is exerted at the adjoining portion C3 between the outer peripheral surface 225a, 225b of each rotor 22a, 22b and the inner peripheral surface 21a of the cylinder 21 at the time of rotating the cylinder 21, can be changed without adding another member.

Furthermore, in the compressor 1 of the present embodiment, the central axis C4 of the outer peripheral surface 225a, 225b of each rotor 22a, 22b and the central axis of the inner peripheral surface 226a, 226b of each rotor 22a, 22b are merely set to be eccentric to each other, so that the assembling of each rotor 22a, 22b is advantageously eased.

Here, the central axis of the inner peripheral surface 21a of the cylinder 21 is set to be eccentric to the rotational central axis C1 that is the central axis of an outer peripheral surface 21b of the cylinder 21, so that the contact stress, which is exerted at the adjoining portion C3 between the rotor 22a, 22b and the cylinder 21, can be changed.

However, the rotary cylinder type compressor 1 has the structure, in which the cylinder 21 is placed on the radially outer side of each rotor 22a, 22b, so that a weight balance in the rotational direction of the cylinder 21 becomes unstable due to the eccentricity between the outer peripheral surface 21b and the inner peripheral surface 21a of the cylinder 21. The unstable weight balance of the rotatable constituent element of the compression mechanism 20, which is configured to rotate, results in unintentional energy loss and is thereby not desirable.

In view of the above point, according to the present embodiment, the central axis C4 of the outer peripheral surface 225a, 225b of each rotor 22a, 22b, which is placed at the inside of the cylinder 21, is placed eccentrically relative to the eccentric axis C2 that serves as the central axis of the inner peripheral surface 226a, 226b of each rotor 22a, 22b. According to this construction, it is possible to limit the unstable weight balance of the rotatable constituent element of the compression mechanism 20, which is configured to rotate.

Furthermore, in the present embodiment, when the refrigerant pressure of the compression space, which compresses the refrigerant, in the compression mechanism 20 reaches the discharge pressure, the contact stress, which is exerted at the adjoining portion C3 between the outer peripheral surface 225a, 225b of the rotor 22a, 22b and the inner peripheral surface 21a of the cylinder 21, is maximized.

Accordingly, when the pressure difference between the refrigerant pressure of each compression space Va_OUT, Vb_OUT and the refrigerant pressure of the corresponding suction space Va_IN, Vb_IN is maximized, the contact stress, which is exerted at the adjoining portion C3, can be increased. Thus, the leakage of the refrigerant from each compression space Va_OUT, Vb_OUT to the corresponding suction space Va_IN, Vb_IN can be effectively limited.

Furthermore, in the compressor 1 of the present embodiment, the compression mechanism 20 is placed on the radially inner side of the electric motor 30, so that the size of the compressor 1 measured in the axial direction can be reduced. Particularly, in the present embodiment, the primary compression mechanism portion 20a and the secondary compression mechanism portion 20b are arranged one after another in the axial direction of the rotational central axis C1 of the cylinder 21, so that the volume of each working chamber Va, Vb can be sufficiently ensured without increasing the size of the compressor 1 measured in the radial direction.

In the compressor 1 of the present embodiment, a maximum volume of the primary working chamber Va and a maximum volume of the secondary working chamber Vb are generally equal to each other. In addition, in the compressor 1 of the present embodiment, the rotational angle θ of the cylinder 21, at which the refrigerant in the primary working chamber Va reaches the discharge pressure, is shifted by 180 degrees from the rotational angle θ of the cylinder 21, at which the refrigerant in the secondary working chamber Vb reaches the maximum pressure.

Accordingly, a torque change of the entire compressor 1 can be limited in comparison to a case where a discharge capacity, which is equal to a total discharge capacity of the primary working chamber Va and the secondary working chamber Vb of the present embodiment, is achieved by the single compression mechanism.

Therefore, the compressor 1 of the present embodiment can limit an increase in the noise and the vibration of the whole compressor 1. A sum value of a torque change, which is caused by a pressure change of the refrigerant in the primary working chamber Va, and a torque change, which is caused by a pressure change of the refrigerant in the secondary working chamber Vb, can be used as the torque change of the whole compressor 1.

In the compressor 1 of the present embodiment, the shaft 24 forms the shaft-side suction passage 24d that is the supply passage, which supplies the refrigerant to the compression mechanism 20. With the above structure, in which the shaft 24 is used to form the supply passage of the refrigerant, the size of the compressor 1 measured in the radial direction can be limited in comparison to a case where a member, which forms the supply passage of the fluid, is provided as a separate member that is different from the shaft 24.

Here, in the present embodiment, the rotational angle θ, at which the refrigerant pressure of the primary compression space Va_OUT, reaches the discharge pressure, is set to be 240 degrees as the example. However, the rotational angle θ, at which the refrigerant pressure of the primary compression space Va_OUT, reaches the discharge pressure, is not necessarily limited to 240 degrees. The rotational angle θ, at which the refrigerant pressure of the primary compression space Va_OUT reaches the discharge pressure, is ideally in a range of 180 degrees to 270 degrees. Therefore, it is desirable to configure each rotor 22a, 22b such that the contact stress, which is exerted at the adjoining portion C3 between the cylinder 21 and the rotor 22a, 22b, is maximized in the above range of the rotational angle θ of the cylinder 21, which is 180 degrees to 270 degrees. This setting is similarly applied to the embodiments discussed below.

### (Modification of First Embodiment)

The first embodiment exemplifies the structure, in which each rotor 22a, 22b and the cylinder 21 contact with each other at the adjoining portion C3 at the rotational angle θ, at which the refrigerant pressure of the corresponding compression space Va_OUT, Vb_OUT reaches the discharge pressure. However, the present disclosure should not be limited to this structure.

For example, the compressor 1 may be configured such that each rotor 22a, 22b and the cylinder 21 do not contact with each other at the rotational angle θ, at which the refrigerant pressure of the corresponding compression space Va_OUT, Vb_OUT reaches the discharge pressure.

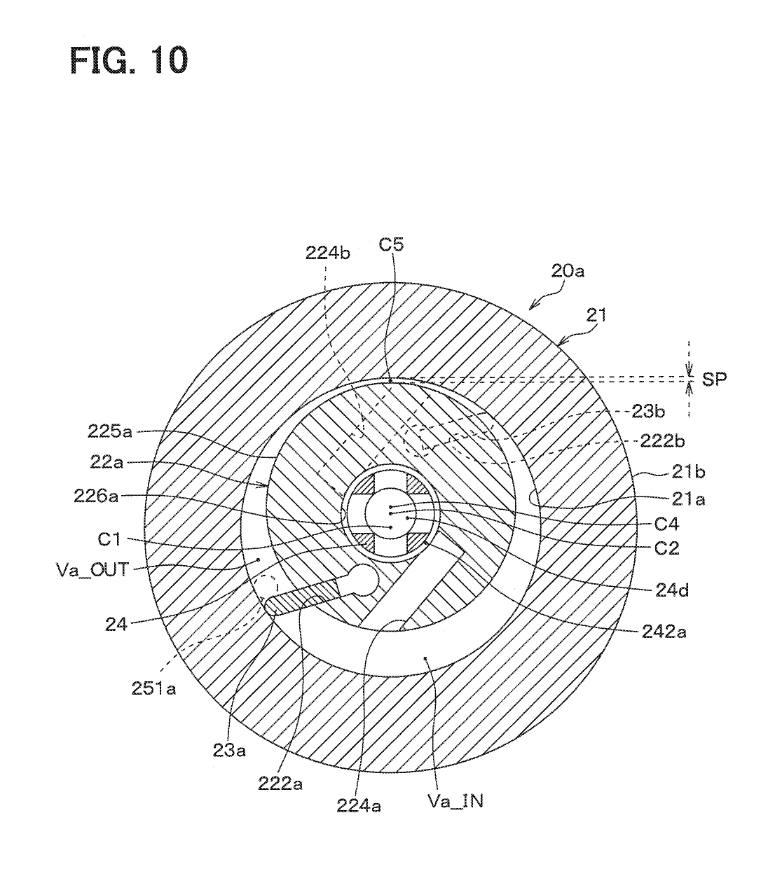

FIG. 10 is an axial cross-sectional view of the compression mechanism 20 of this modification. FIG. 10 corresponds to FIG. 8 of the first embodiment and shows the axial cross section of the primary compression mechanism portion 20a at the rotational angle θ, at which the refrigerant pressure of the primary compression space Va_OUT reaches the discharge pressure.

As shown in FIG. 10, the compressor 1 is configured such that a size SP of the minimum gap C5 between the cylinder 21 and each rotor 22a, 22b is reduced when the pressure difference between the refrigerant pressure of the corresponding suction space Va_IN, Vb_IN and the refrigerant pressure of the corresponding compression space Va_OUT, Vb_OUT is increased. In other words, the compressor 1 of the present modification is configured such that when the refrigerant pressure of each compression space Va_OUT, Vb_OUT becomes equal to or larger than the predetermined reference pressure, the size SP of the minimum gap C5 between the cylinder 21 and the corresponding rotor 22a, 22b is reduced in comparison to the case where the refrigerant pressure of the compression space Va_OUT, Vb_OUT becomes smaller than the predetermined reference pressure. The minimum gap C5 is a gap that has a smallest size, which is measured between the inner peripheral surface 21a of the cylinder 21 and the outer peripheral surface 225a, 225b of the rotor 22a, 22b, among gaps defined between the inner peripheral surface 21a of the cylinder 21 and the outer peripheral surface 225a, 225b of the rotor 22a, 22b.

Specifically, similar to the first embodiment, the central axis C4 of the outer peripheral surface 225a, 225b of each rotor 22a, 22b of the present modification is set to be eccentric to the eccentric axis C2, which is the central axis of the inner peripheral surface 226a, 226b of the rotor 22a, 22b.

Furthermore, each rotor 22a, 22b of the present modification is configured such that a radius of a portion of the outer peripheral surface 225a, 225b, at which the thickness of the rotor 22a, 22b is maximum, is smaller than the radius of the inner peripheral surface 21a of the cylinder 21. Also, each rotor 22a, 22b of the present modification is configured such that the size of the minimum gap C5 between the cylinder 21 and the rotor 22a, 22b is minimized in the range of rotational angle θ, throughout which the refrigerant pressure of the corresponding compression space Va_OUT, Vb_OUT is equal to or larger than the predetermined reference pressure.

More specifically, the primary rotor 22a is configured such that the minimum gap C5, the central axis C4 of the outer peripheral surface 225a of the primary rotor 22a, and the eccentric axis C2 are arranged one after another in this order along a straight line at the rotational angle θ, at which the refrigerant pressure of the primary compression space Va_OUT reaches the discharge pressure.

Similarly, the secondary rotor 22b is configured such that the minimum gap C5, the central axis C4 of the outer peripheral surface 225b of the secondary rotor 22b, and the eccentric axis C2 are arranged one after another in this order along a straight line at the rotational angle θ, at which the refrigerant pressure of the secondary compression space Vb_OUT reaches the discharge pressure.

Here, FIG. 11 is a descriptive diagram for describing a change in the refrigerant pressure of the primary compression space Va_OUT and a change in the size SP of the minimum gap C5 at the time of changing the rotational angle θ of the cylinder 21 from 0 degrees to 360 degrees after completion of the suctioning of the refrigerant into the primary working chamber Va.

In FIG. 11, a change in the refrigerant pressure of the primary compression space Va_OUT and a change in the size SP of the minimum gap C5 between the cylinder 21 and the primary rotor 22a are indicated by solid lines, respectively. Furthermore, in FIG. 11, a change in the refrigerant pressure of the secondary compression space Vb_OUT and a change in the size SP of the minimum gap C5 between the cylinder 21 and the secondary rotor 22b are indicated by dotted lines, respectively.

As indicated by the solid line in FIG. 11, when the rotational angle θ of the cylinder 21 is increased from 0 degrees, the refrigerant pressure of the primary compression space Va_OUT is progressively increased. When the rotational angle θ of the cylinder 21 reaches around 240 degrees, the refrigerant pressure of the primary compression space Va_OUT reaches the discharge pressure. Thus, the primary discharge valve 26a is opened. Thereby, the refrigerant in the primary compression space Va_OUT is discharged to the inside space of the housing 10 through the primary discharge hole 251a.

At this time, the minimum gap C5, the central axis C4 of the outer peripheral surface 225a of the primary rotor 22a and the eccentric axis C2 are arranged one after another along the straight line, so that the size SP of the minimum gap C5, which is defined between the outer peripheral surface 225a of the primary rotor 22a and the inner peripheral surface 21a of the cylinder 21, is minimized. Therefore, in the primary compression mechanism portion 20a of the present modification, the leakage of the refrigerant from the primary compression space Va_OUT to the primary suction space Va_IN can be effectively limited.

Furthermore, in the primary compression mechanism portion 20a of the present modification, the size SP of the minimum gap C5 between the cylinder 21 and the primary rotor 22a is increased until the refrigerant pressure of the primary compression space Va_OUT reaches the discharge pressure. Therefore, in the primary compression mechanism portion 20a of the present modification, the outer peripheral surface 225a of the primary rotor 22a and the inner peripheral surface 21a of the cylinder 21 are less likely to contact with each other. Thus, the slide loss between the inner peripheral surface 21a of the cylinder 21 and the outer peripheral surface 225a of the primary rotor 22a can be effectively limited.

Next, as indicated by the dotted line in FIG. 11, when the rotational angle θ of the cylinder 21 reaches around 180 degrees, the suctioning of the refrigerant at the secondary working chamber Vb is completed. Then, when the rotational angle θ of the cylinder 21 is increased from 180 degrees, the refrigerant pressure of the secondary compression space Vb_OUT is progressively increased. When the rotational angle θ of the cylinder 21 reaches around 420 degrees, the refrigerant pressure of the secondary compression space Vb_OUT reaches the discharge pressure. Thereby, the secondary discharge valve 26b is opened. In this way, the refrigerant of the secondary compression space Vb_OUT is discharged to the inside space of the housing 10 through the secondary discharge hole 251b.

At this time, in the secondary compression mechanism portion 20b, when the refrigerant pressure of the secondary compression space Vb_OUT reaches the discharge pressure, the size SP of the minimum gap C5 between the inner peripheral surface 21a of the cylinder 21 and the outer peripheral surface 225b of the secondary rotor 22b is minimized.

Therefore, in the secondary compression mechanism portion 20b of the present modification, the leakage of the refrigerant from the secondary compression space Vb_OUT to the secondary suction space Vb_IN can be effectively limited. Furthermore, in the secondary compression mechanism portion 20b of the present modification, the size SP of the minimum gap C5 between the cylinder 21 and the secondary rotor 22b is increased until the refrigerant pressure of the secondary compression space Vb_OUT reaches the discharge pressure. Thus, in the secondary compression mechanism portion 20b of the present modification, the slide loss between the inner peripheral surface 21a of the cylinder 21 and the outer peripheral surface 225b of the secondary rotor 22b can be effectively limited.

In the present modification discussed above, the effects and advantages, which can be achieved with the common structure that is common to the first embodiment, can be achieved like the structure of the first embodiment.

Particularly, in the present modification, the minimum gap C5 between the outer peripheral surface 225a, 225b of each rotor 22a, 22b and the inner peripheral surface 21a of the cylinder 21 is reduced when the refrigerant pressure of the compression space, which compresses the refrigerant, in the compression mechanism 20 is increased. Thereby, the leakage of the refrigerant from each compression space Va_OUT, Vb_OUT to the suction space Va_IN, Vb_IN can be effectively limited.

Furthermore, in the present modification, when the refrigerant pressure of the compression space, which compresses the refrigerant, in the compression mechanism 20 is reduced, the outer peripheral surface 225a, 225b of each rotor 22a, 22b and the inner peripheral surface 21a of the cylinder 21 are less likely to contact each other. Thus, the slide loss between the inner peripheral surface 21a of the cylinder 21 and the outer peripheral surface 225a, 225b of each rotor 22a, 22b can be effectively limited.

Therefore, the compressor 1 of the present modification effectively limits the compression loss and the slide loss like the compressor 1 of the first embodiment, so that the compression performance for compressing the refrigerant at the compression mechanism 20 can be improved.

### Second Embodiment

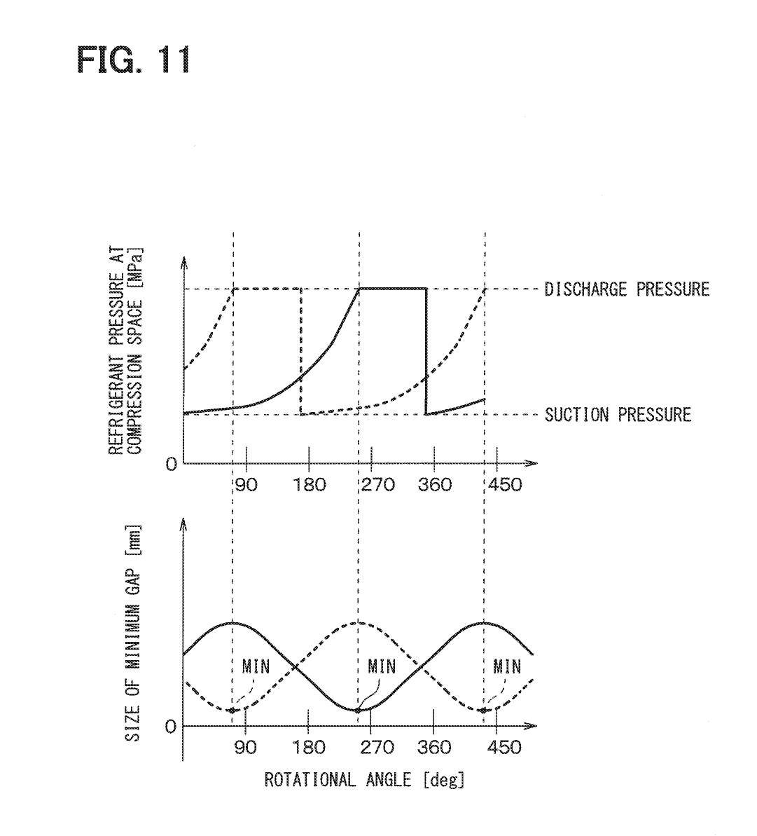

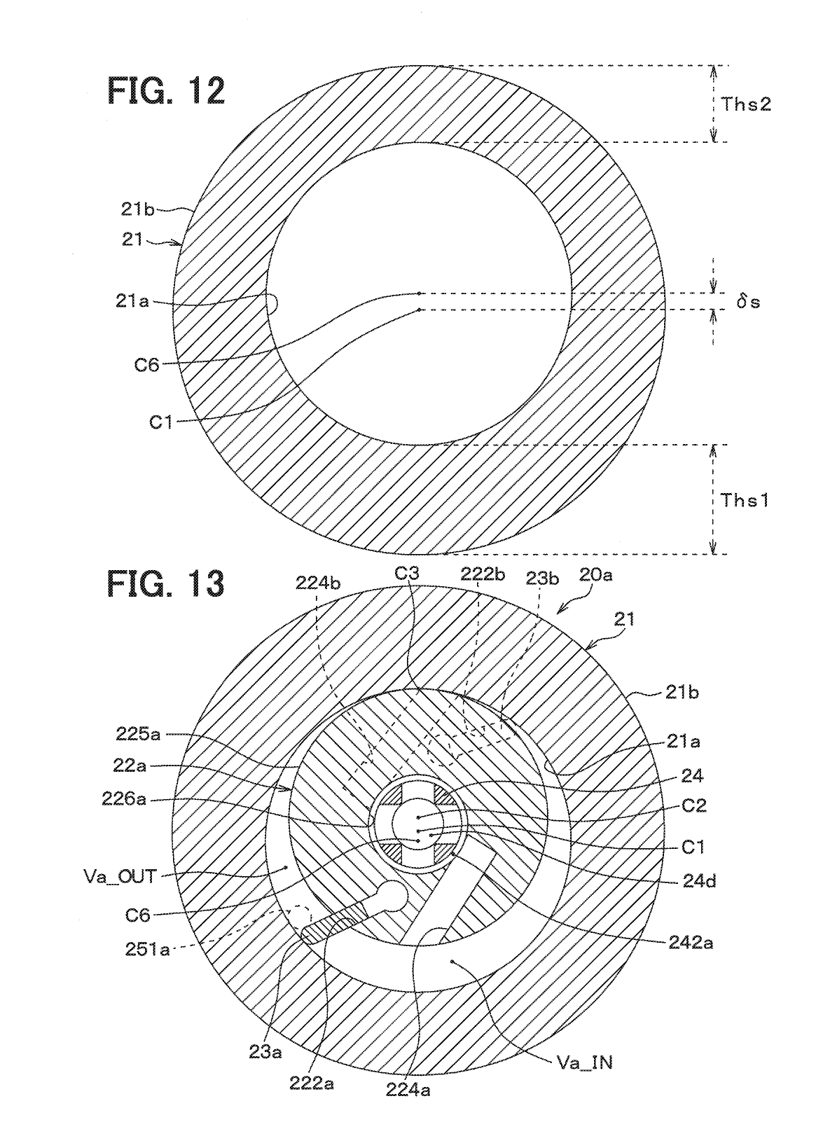

Next, a second embodiment will be described with reference to FIGS. 12 and 13. In the present embodiment, the central axis C6 of the inner peripheral surface 21a of the cylinder 21 is set to be eccentric to the rotational central axis C1 that is the central axis of the outer peripheral surface 21b of the cylinder 21 instead of each rotor 22a, 22b. Each rotor 22a, 22b of the present embodiment is constructed such that the central axis C4 of the outer peripheral surface 225a, 225b of the rotor 22a, 22b is coaxial with the eccentric axis C2.

In the present embodiment, as shown in FIG. 12, the central axis C6 of the inner peripheral surface 21a of the cylinder 21 is set to be eccentric to the rotational central axis C1 that is the central axis of the outer peripheral surface 21b of the cylinder 21. Thereby, the thickness of the cylinder 21 varies in the circumferential direction of the cylinder 21. For example, a maximum value Ths1 of the thickness of the cylinder 21 is set to be larger than a minimum value Ths2 of the thickness of the cylinder 21 by the amount that corresponds to the amount of eccentricity δs between the central axis C6 of the inner peripheral surface 21a and the rotational central axis C1.

Here, the cylinder 21 of the present embodiment is configured such that a radius of a portion of the inner peripheral surface 21a, at which the thickness of the cylinder 21 is maximum, is equal to or smaller than a radius of the outer peripheral surface 225a, 225b of each rotor 22a, 22b. Furthermore, the cylinder 21 of the present embodiment is configured such that a radius of a portion of the inner peripheral surface 21a, at which the thickness of the cylinder 21 is minimum, is larger than a radius of the outer peripheral surface 225a, 225b of each rotor 22a, 22b.

FIG. 13 shows an axial cross section of the primary compression mechanism portion 20a at the rotational angle θ (e.g., 240 degrees), at which the refrigerant pressure of the primary compression space Va_OUT reaches the discharge pressure. As shown in FIG. 13, the cylinder 21 is configured such that the contact stress, which is exerted at the adjoining portion C3 between the cylinder 21 and each rotor 22a, 22b, is maximized in the range of rotational angle θ, throughout which the refrigerant pressure of the corresponding compression space Va_OUT, Vb_OUT is equal to or larger than the predetermined reference pressure.

The rest of the structure is the same as that of the first embodiment. The compressor 1 of the present embodiment can achieve the effects and advantages, which can be achieved with the common structure that is common to the first embodiment, like the structure of the first embodiment.

### (Modification of Second Embodiment)

The second embodiment exemplifies the structure, in which each rotor 22a, 22b and the cylinder 21 contact with each other at the adjoining portion C3 at the rotational angle θ, at which the refrigerant pressure of the corresponding compression space Va_OUT, Vb_OUT reaches the discharge pressure. However, the present disclosure should not be limited to this structure.

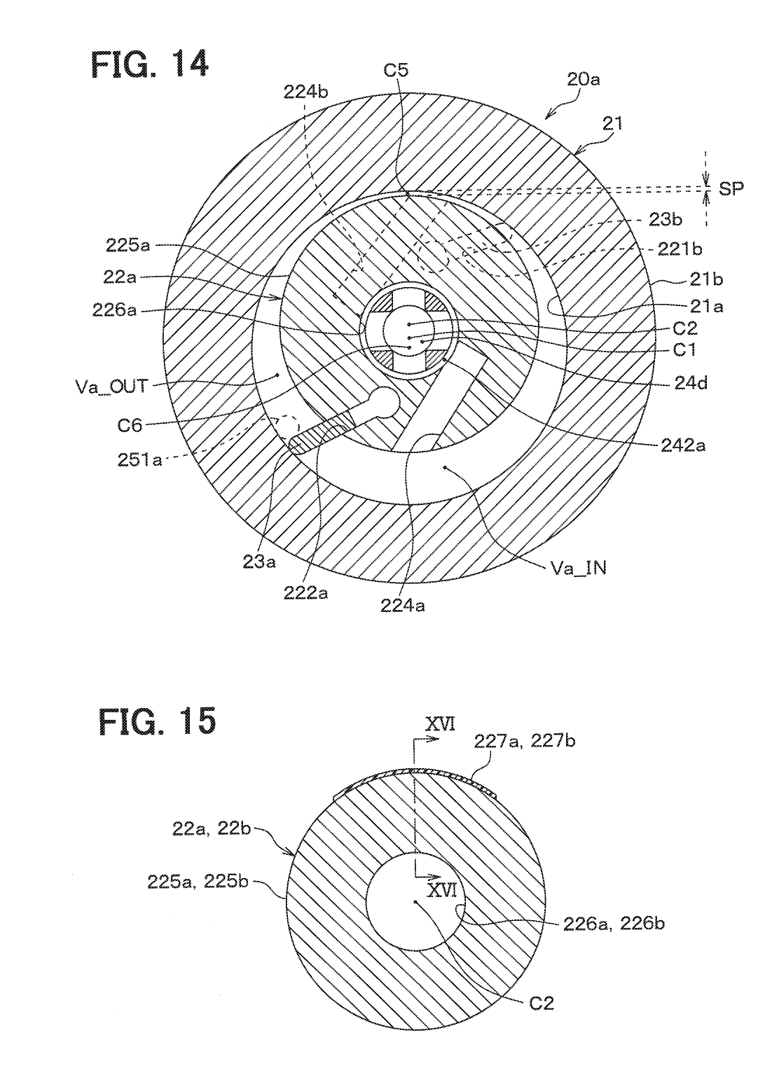

For example, as shown in FIG. 14, the compressor 1 may be configured such that each rotor 22a, 22b and the cylinder 21 do not contact with each other at the rotational angle θ, at which the refrigerant pressure of the primary compression space Va_OUT reaches the discharge pressure. FIG. 14 corresponds to FIG. 13 of the second embodiment and shows the axial cross section of the primary compression mechanism portion 20a at the rotational angle θ, at which the refrigerant pressure of the primary compression space Va_OUT reaches the discharge pressure.

### Third Embodiment

Next, a third embodiment will be described with reference to FIGS. 15 to 18. The present embodiment differs from the first embodiment with respect to that a protrusion 227a, 227b is formed at a part of the outer peripheral surface 225a, 225b of each rotor 22a, 22b in the present embodiment. Each rotor 22a, 22b of the present embodiment is constructed such that the central axis C4 of the outer peripheral surface 225a, 225b of the rotor 22a, 22b is coaxial with the eccentric axis C2.

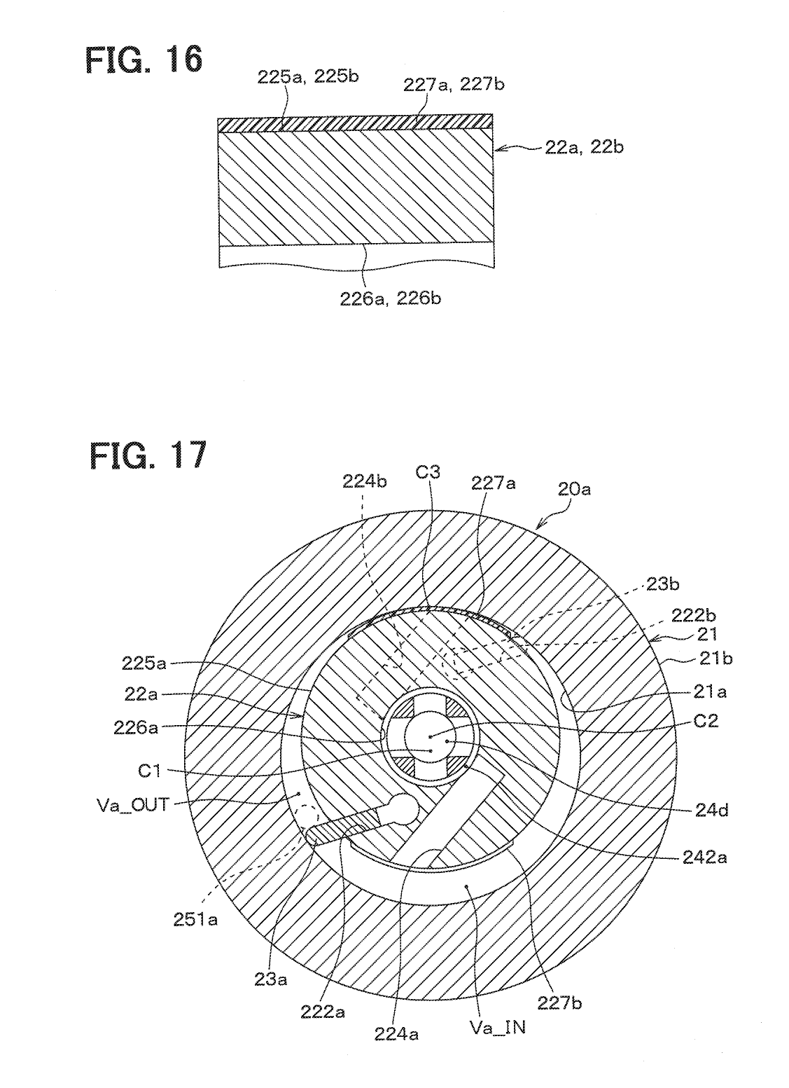

In the present embodiment, as shown in FIGS. 15 and 16, the protrusion 227a, 227b, which protrudes toward the inner peripheral surface 21a of the cylinder 21, is formed at the part of the outer peripheral surface 225a, 225b of each rotor 22a, 22b. Thereby, a thickness of each rotor 22a, 22b varies in the circumferential direction of the rotor 22a, 22b.

The protrusion 227a, 227b of each rotor 22a, 22b can be formed by, for example, a surface treatment that applies resin to the outer peripheral surface 225a, 225b of each rotor 22a, 22b. Alternatively, the protrusion 227a, 227b may be formed by a machining process, such as cutting.

The protrusion 227a, 227b of each rotor 22a, 22b is formed at the corresponding part of the rotor 22a, 22b that contacts the inner peripheral surface 21a of the cylinder 21 in the range of rotational angle θ, throughout which the refrigerant pressure of the corresponding compression space Va_OUT, Vb_OUT is equal to or larger than the predetermined reference pressure.

Specifically, the protrusion 227a, 227b is formed at the corresponding part of the rotor 22a, 22b that contacts the inner peripheral surface 21a of the cylinder 21 in the range (e.g., 200 degrees to 300 degrees) that straddles the rotational angle θ, at which the refrigerant pressure of the corresponding compression space Va_OUT, Vb_OUT reaches the discharge pressure.

Thereby, each rotor 22a, 22b is configured such that the contact stress, which is exerted at the adjoining portion C3 between the cylinder 21 and the rotor 22a, 22b, is maximized in the range of rotational angle θ, throughout which the refrigerant pressure of the corresponding compression space Va_OUT, Vb_OUT is equal to or larger than the predetermined reference pressure.

Here, FIG. 17 shows an axial cross section of the primary compression mechanism portion 20a at the rotational angle θ (e.g., 240 degrees), at which the refrigerant pressure of the primary compression space Va_OUT reaches the discharge pressure. As shown in FIG. 17, the primary rotor 22a is configured such that the protrusion 227a of the primary rotor 22a contacts the inner peripheral surface 21a of the cylinder 21 at the rotational angle θ, at which the refrigerant pressure of the primary compression space Va_OUT reaches the discharge pressure.

Similarly, the secondary rotor 22b is configured such that the protrusion 227b of the secondary rotor 22b contacts the inner peripheral surface 21a of the cylinder 21 at the rotational angle θ, at which the refrigerant pressure of the secondary compression space Vb_OUT reaches the discharge pressure. Here, the secondary rotor 22b may be configured such that the protrusion 227b of the secondary rotor 22b contacts the inner peripheral surface 21a of the cylinder 21 at the corresponding rotational angle θ that is the angle of the cylinder 21 rotated by 180 degrees from the rotational angle θ, at which the refrigerant pressure of the primary compression space Va_OUT reaches the discharge pressure.

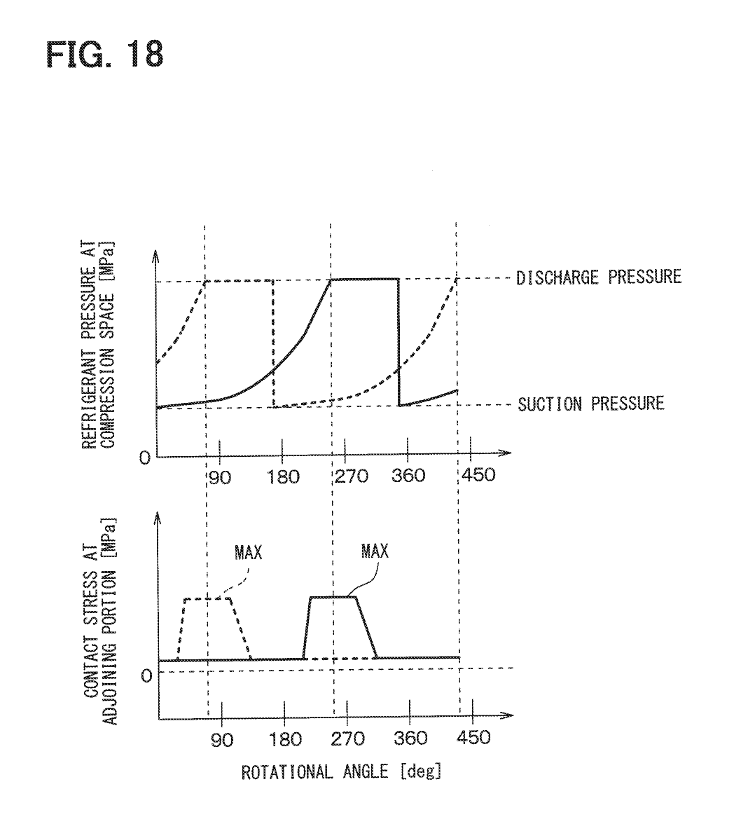

Here, FIG. 18 is a descriptive diagram for describing a change in the refrigerant pressure of the primary compression space Va_OUT and a change in the contact stress at the adjoining portion C3 at the time of changing the rotational angle θ of the cylinder 21 from 0 degrees to 360 degrees after completion of the suctioning of the refrigerant into the primary working chamber Va.

In FIG. 18, the change in the refrigerant pressure of the primary compression space Va_OUT and the change in the contact stress at the adjoining portion C3 between the cylinder 21 and the primary rotor 22a are indicated by solid lines, respectively. Furthermore, in FIG. 18, a change in the refrigerant pressure of the secondary compression space Vb_OUT and a change in the contact stress at the adjoining portion C3 between the cylinder 21 and the secondary rotor 22b are indicated by dotted lines, respectively.

As indicated by the solid line in FIG. 18, when the rotational angle θ of the cylinder 21 is increased from 0 degrees, the refrigerant pressure of the primary compression space Va_OUT is progressively increased. When the rotational angle θ of the cylinder 21 reaches around 240 degrees, the refrigerant pressure of the primary compression space Va_OUT reaches the discharge pressure. Thus, the primary discharge valve 26a is opened. Thereby, the refrigerant in the primary compression space Va_OUT is discharged to the inside space of the housing 10 through the primary discharge hole 251a.

At this time, the contact stress, which is exerted at the adjoining portion C3, is maximized because of the contact of the protrusion 227a of the primary rotor 22a to the inner peripheral surface 21a of the cylinder 21. Specifically, in the primary compression mechanism portion 20a of the present embodiment, when the refrigerant pressure of the primary compression space Va_OUT reaches the discharge pressure, the contact stress between the cylinder 21 and the primary rotor 22a is maximized. Therefore, in the primary compression mechanism portion 20a of the present embodiment, the leakage of the refrigerant from the primary compression space Va_OUT to the primary suction space Va_IN can be effectively limited.

Furthermore, in the primary compression mechanism portion 20a of the present embodiment, the contact stress between the cylinder 21 and the primary rotor 22a is small until the refrigerant pressure of the primary compression space Va_OUT reaches the discharge pressure. Therefore, in the primary compression mechanism portion 20a of the present embodiment, the slide loss between the inner peripheral surface 21a of the cylinder 21 and the outer peripheral surface 225a of the primary rotor 22a can be limited while the amount of leakage of the refrigerant from the primary compression space Va_OUT to the primary suction space Va_IN is limited.

Next, as indicated by the dotted line in FIG. 18, when the rotational angle θ of the cylinder 21 reaches around 180 degrees, the suctioning of the refrigerant at the secondary working chamber Vb is completed. Then, when the rotational angle θ of the cylinder 21 is increased from 180 degrees, the refrigerant pressure of the secondary compression space Vb_OUT is progressively increased. When the rotational angle θ of the cylinder 21 reaches around 420 degrees, the refrigerant pressure of the secondary compression space Vb_OUT reaches the discharge pressure. Thereby, the secondary discharge valve 26b is opened. In this way, the refrigerant of the secondary compression space Vb_OUT is discharged to the inside space of the housing 10 through the secondary discharge hole 251b.

At this time, the contact stress, which is exerted at the adjoining portion C3, is maximized because of the contact of the protrusion 227b of the secondary rotor 22b to the inner peripheral surface 21a of the cylinder 21. Specifically, in the secondary compression mechanism portion 20b, when the refrigerant pressure of the secondary compression space Vb_OUT reaches the discharge pressure; the contact stress, which is exerted of the adjoining portion C3 between the inner peripheral surface 21a of the cylinder 21 and the outer peripheral surface 225b of the secondary rotor 22b, is maximized.

Therefore, in the secondary compression mechanism portion 20b of the present embodiment, the leakage of the refrigerant from the secondary compression space Vb_OUT to the secondary suction space Vb_IN can be effectively limited. Furthermore, in the secondary compression mechanism portion 20b of the present embodiment, the contact stress between the cylinder 21 and the secondary rotor 22b is small until the refrigerant pressure of the secondary compression space Vb_OUT reaches the discharge pressure. Thus, in the secondary compression mechanism portion 20b of the present embodiment, the slide loss between the inner peripheral surface 21a of the cylinder 21 and the outer peripheral surface 225b of the secondary rotor 22b can be limited while the leakage of the refrigerant from the secondary compression space Vb_OUT to the secondary suction space Vb_IN is limited.

The rest of the structure is the same as that of the first embodiment. The compressor 1 of the present embodiment can achieve the effects and advantages, which can be achieved with the common structure that is common to the first embodiment, like the structure of the first embodiment. That is, the compressor 1 of the present embodiment effectively limits the compression loss and the slide loss, so that the compression performance for compressing the refrigerant at the compression mechanism 20 can be improved.

### (Modification of Third Embodiment)

The third embodiment exemplifies the structure, in which each rotor 22a, 22b and the cylinder 21 contact with each other at the adjoining portion C3 at the rotational angle θ, at which the refrigerant pressure of the corresponding compression space Va_OUT, Vb_OUT reaches the discharge pressure. However, the present disclosure should not be limited to this structure.

For example, the compressor 1 may be configured such that each rotor 22a, 22b and the cylinder 21 do not contact with each other at the rotational angle θ, at which the refrigerant pressure of the corresponding compression space Va_OUT, Vb_OUT reaches the discharge pressure.

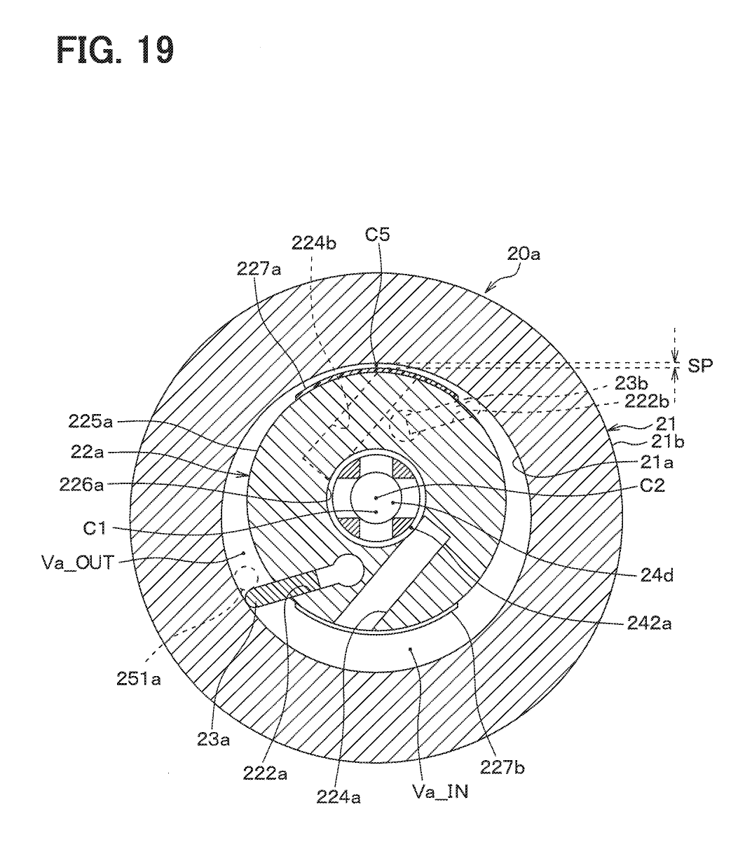

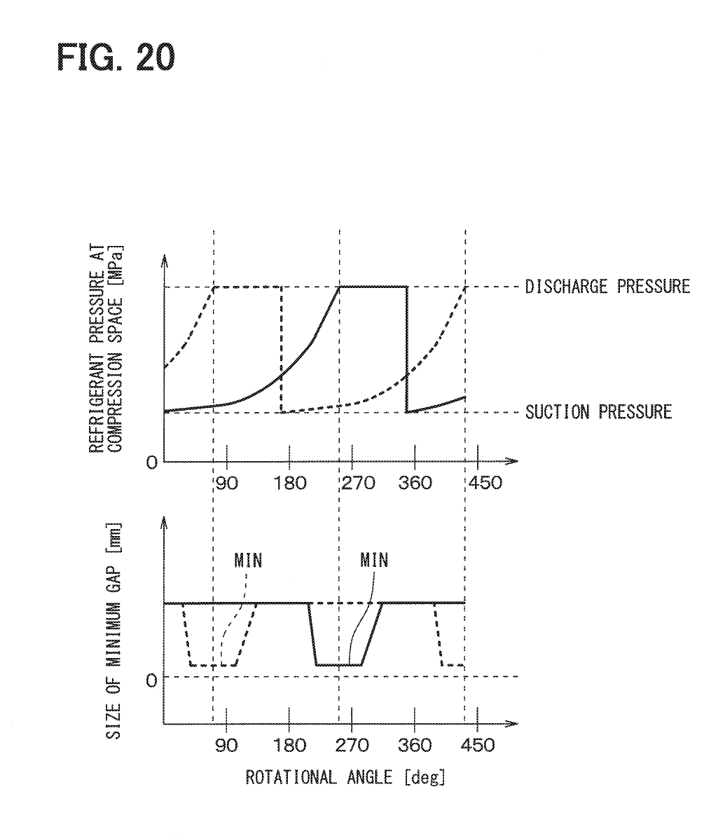

FIG. 19 is an axial cross-sectional view of the compression mechanism 20 of this modification. FIG. 19 corresponds to FIG. 17 of the third embodiment and shows the axial cross section of the primary compression mechanism portion 20a at the rotational angle θ, at which the refrigerant pressure of the primary compression space Va_OUT reaches the discharge pressure.

As indicated in FIG. 19, in the present modification, the protrusion 227a, 227b of each rotor 22a, 22b is formed at a corresponding part of the rotor 22a, 22b that is most closely placed relative to the inner peripheral surface 21a of the cylinder 21 in the range of rotational angle θ, throughout which the refrigerant pressure of the corresponding compression space Va_OUT, Vb_OUT is equal to or larger than the predetermined reference pressure. Thereby, in the present modification, the compressor 1 is configured such that the size SP of the minimum gap C5 between the cylinder 21 and each rotor 22a, 22b is reduced when the pressure difference between the refrigerant pressure of the corresponding suction space Va_IN, Vb_IN and the refrigerant pressure of the corresponding compression space Va_OUT, Va_OUT is increased. In other words, in the present modification, when the refrigerant pressure of each compression space Va_OUT, Vb_OUT becomes equal to or larger than the predetermined reference pressure, the size SP of the minimum gap C5 between the cylinder 21 and the corresponding rotor 22a, 22b is reduced in comparison to the case where the refrigerant pressure of the compression space Va_OUT, Vb_OUT becomes smaller than the predetermined reference pressure.

Here, FIG. 20 is a descriptive diagram for describing a change in the refrigerant pressure of the primary compression space Va_OUT and a change in the size SP of the minimum gap C5 at the time of changing the rotational angle θ of the cylinder 21 from 0 degrees to 360 degrees after completion of the suctioning of the refrigerant into the primary working chamber Va.

In FIG. 20, a change in the refrigerant pressure of the primary compression space Va_OUT and a change in the size SP of the minimum gap C5 between the cylinder 21 and the primary rotor 22a are indicated by solid lines, respectively. Furthermore, in FIG. 20, a change in the refrigerant pressure of the secondary compression space Vb_OUT and a change in the size SP of the minimum gap C5 between the cylinder 21 and the secondary rotor 22b are indicated by dotted lines, respectively.

As indicated by the solid line in FIG. 20, when the rotational angle θ of the cylinder 21 is increased from 0 degrees, the refrigerant pressure of the primary compression space Va_OUT is progressively increased. When the rotational angle θ of the cylinder 21 reaches around 240 degrees, the refrigerant pressure of the primary compression space Va_OUT reaches the discharge pressure. Thus, the primary discharge valve 26a is opened. Thereby, the refrigerant in the primary compression space Va_OUT is discharged to the inside space of the housing 10 through the primary discharge hole 251a.

At this time, the protrusion 227a of the primary rotor 22a is placed in the closest position to the inner peripheral surface 21a of the cylinder 21, so that the size SP of the minimum gap C5 between the inner peripheral surface 21a of the cylinder 21 and the outer peripheral surface 225a of the primary rotor 22a becomes minimum. Therefore, in the primary compression mechanism portion 20a of the present modification, the leakage of the refrigerant from the primary compression space Va_OUT to the primary suction space Va_IN can be effectively limited.

Furthermore, in the primary compression mechanism portion 20a of the present modification, the size SP of the minimum gap C5 between the cylinder 21 and the primary rotor 22a is increased until the refrigerant pressure of the primary compression space Va_OUT reaches the discharge pressure. Therefore, in the primary compression mechanism portion 20a of the present modification, the outer peripheral surface 225a of the primary rotor 22a and the inner peripheral surface 21a of the cylinder 21 are less likely to contact with each other. Thus, the slide loss between the inner peripheral surface 21a of the cylinder 21 and the outer peripheral surface 225a of the primary rotor 22a can be effectively limited.

Next, as indicated by the dotted line in FIG. 20, when the rotational angle θ of the cylinder 21 reaches around 180 degrees, the suctioning of the refrigerant at the secondary working chamber Vb is completed. Then, when the rotational angle θ of the cylinder 21 is increased from 180 degrees, the refrigerant pressure of the secondary compression space Vb_OUT is progressively increased. When the rotational angle θ of the cylinder 21 reaches around 420 degrees, the refrigerant pressure of the secondary compression space Vb_OUT reaches the discharge pressure. Thereby, the secondary discharge valve 26b is opened. In this way, the refrigerant of the secondary compression space Vb_OUT is discharged to the inside space of the housing 10 through the secondary discharge hole 251b.

At this time, the protrusion 227b of the secondary rotor 22b is placed in the closest position to the inner peripheral surface 21a of the cylinder 21, so that the size SP of the minimum gap C5 between the inner peripheral surface 21a of the cylinder 21 and the outer peripheral surface 225b of the secondary rotor 22b becomes minimum. Therefore, in the secondary compression mechanism portion 20b of the present modification, the leakage of the refrigerant from the secondary compression space Vb_OUT to the secondary suction space Vb_IN can be effectively limited. Furthermore, in the secondary compression mechanism portion 20b of the present modification, the size SP of the minimum gap C5 between the cylinder 21 and the secondary rotor 22b is increased until the refrigerant pressure of the secondary compression space Vb_OUT reaches the discharge pressure. Thus, in the secondary compression mechanism portion 20b of the present modification, the slide loss between the inner peripheral surface 21a of the cylinder 21 and the outer peripheral surface 225b of the secondary rotor 22b can be effectively limited.

In the present modification discussed above, the effects and advantages, which can be achieved with the common structure that is common to the third embodiment, can be achieved like the structure of third embodiment. Specifically, the compressor 1 of the present modification effectively limits the compression loss and the slide loss like the compressor 1 of the third embodiment, so that the compression performance for compressing the refrigerant at the compression mechanism 20 can be improved.

### Fourth Embodiment

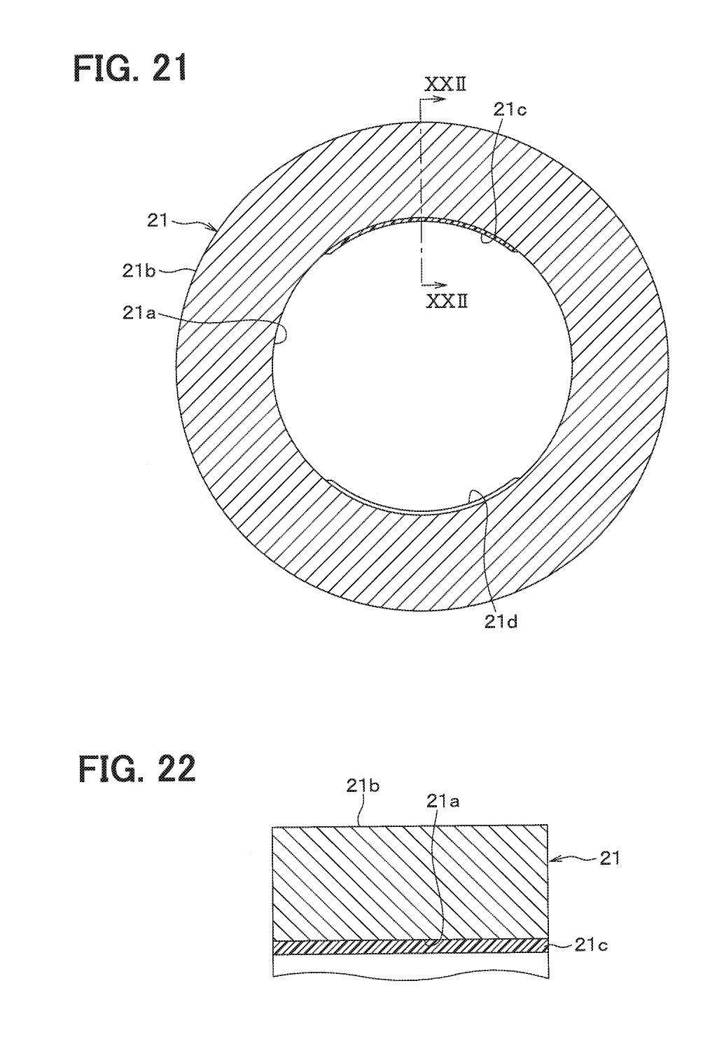

Next, a fourth embodiment will be described with reference to FIGS. 21 to 23. The present embodiment differs from the first embodiment with respect to that protrusions 21c, 21d are respectively formed at corresponding parts of the inner peripheral surface 21a of the cylinder 21 in the present embodiment. Each rotor 22a, 22b of the present embodiment is constructed such that the central axis C4 of the outer peripheral surface 225a, 225b of the rotor 22a, 22b is coaxial with the eccentric axis C2.

In the present embodiment, as shown in FIGS. 21 and 22, the two protrusions 21c, 21d, which protrude toward the outer peripheral surface 225a, 225b of each rotor 22a, 22b, are respectively formed at the corresponding parts of the inner peripheral surface 21a of the cylinder 21. Thereby, the thickness of the cylinder 21 varies in the circumferential direction of the cylinder 21.

The protrusions 21c, 21d of the cylinder 21 can be formed by, for example, a surface treatment that applies resin to the inner peripheral surface 21a of the cylinder 21. Alternatively, the protrusions 21c, 21d may be formed by a machining process, such as cutting.

Each protrusion 21c, 21d of the cylinder 21 is formed at the corresponding part of the cylinder 21 that contacts the outer peripheral surface 225a, 225b of the corresponding rotor 22a, 22b in the range of rotational angle θ, throughout which the refrigerant pressure of the corresponding compression space Va_OUT, Vb_OUT is equal to or larger than the predetermined reference pressure.

Specifically, the primary protrusion 21c is formed at the corresponding part of the cylinder 21 that contacts the outer peripheral surface 225a of the primary rotor 22a in the range that straddles the rotational angle θ, at which the refrigerant pressure of the primary compression space Va_OUT reaches the discharge pressure. Furthermore, the secondary protrusion 21d is formed at the corresponding part of the cylinder 21 that contacts the outer peripheral surface 225b of the secondary rotor 22b in the range that straddles the rotational angle θ, at which the refrigerant pressure of the secondary compression space Vb_OUT reaches the discharge pressure.

Thereby, the cylinder 21 is configured such that the contact stress, which is exerted at the adjoining portion C3 between the cylinder 21 and the rotor 22a, 22b, is maximized in a range of rotational angle θ, throughout which the refrigerant pressure of the corresponding compression space Va_OUT, Vb_OUT is equal to or larger than the predetermined reference pressure.

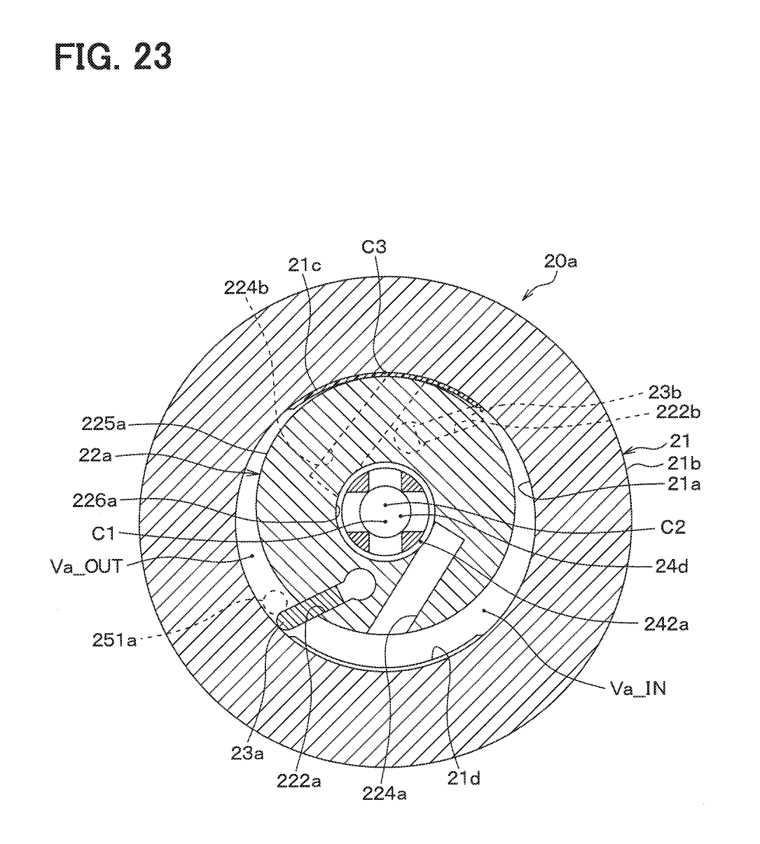

Here, FIG. 23 shows an axial cross section of the primary compression mechanism portion 20a at the rotational angle θ (e.g., 240 degrees), at which the refrigerant pressure of the primary compression space Va_OUT reaches the discharge pressure. As shown in 23, the cylinder 21 is configured such that the protrusion 21c contacts the outer peripheral surface 225a of the primary rotor 22a at the rotational angle θ, at which the refrigerant pressure of the primary compression space Va_OUT reaches the discharge pressure.

Furthermore, the cylinder 21 is configured such that the protrusion 21d contacts the outer peripheral surface 225b of the secondary rotor 22b at the rotational angle θ, at which the refrigerant pressure of the secondary compression space Vb_OUT reaches the discharge pressure. Here, the protrusion 21d of the cylinder 21 may be configured such that the protrusion 21d contacts the outer peripheral surface 225b of the secondary rotor 22b at the corresponding rotational angle θ that is an angle of the cylinder 21 rotated by 180 degrees from the rotational angle θ, at which the refrigerant pressure of the primary compression space Va_OUT reaches the discharge pressure.

The rest of the structure is the same as that of the first embodiment. The compressor 1 of the present embodiment can achieve the effects and advantages, which can be achieved with the common structure that is common to the first embodiment, like the structure of first embodiment. That is, the compressor 1 of the present embodiment effectively limits the compression loss and the slide loss, so that the compression performance for compressing the refrigerant at the compression mechanism 20 can be improved.

### (Modification of Fourth Embodiment)

The fourth embodiment exemplifies the structure, in which each rotor 22a, 22b and the cylinder 21 contact with each other at the rotational angle θ, at which the refrigerant pressure of the corresponding compression space Va_OUT, Vb_OUT reaches the discharge pressure. However, the present disclosure should not be limited to this structure.

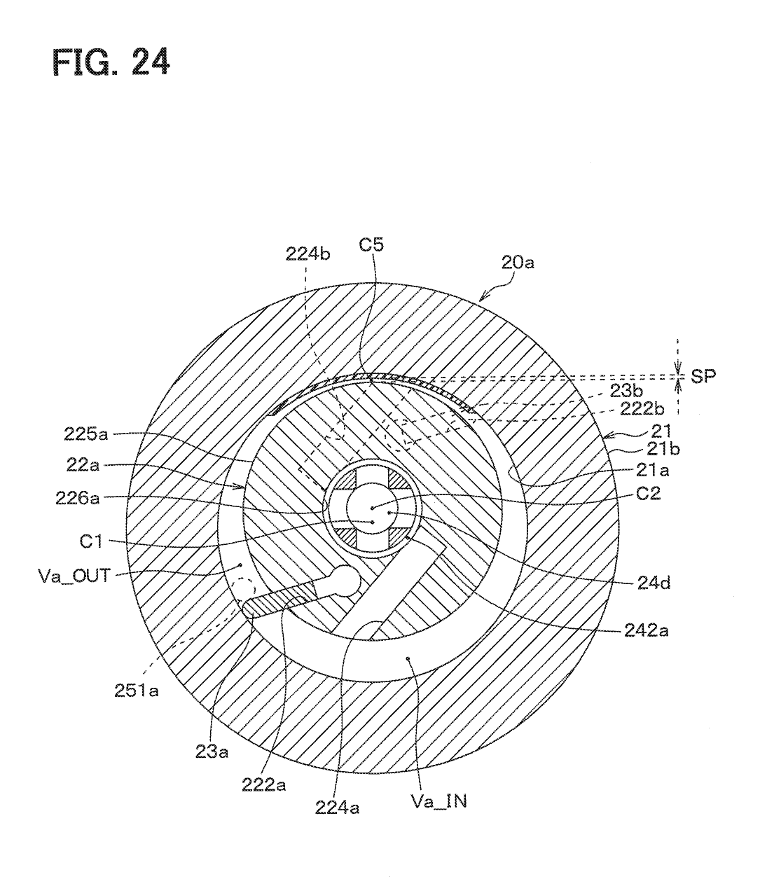

For example, the compressor 1 may be configured such that each rotor 22a, 22b and the cylinder 21 do not contact with each other at the rotational angle θ, at which the refrigerant pressure of the primary compression space Va_OUT reaches the discharge pressure. As indicated in FIG. 24, each protrusion 21c, 21d may be formed at a corresponding part of the cylinder 21 that is most closely placed relative to the outer peripheral surface 225a, 225b of the corresponding rotor 22a, 22b in the range of rotational angle θ, throughout which the refrigerant pressure of the corresponding compression space Va_OUT, Vb_OUT is equal to or larger than the predetermined reference pressure. FIG. 24 corresponds to FIG. 23 of the fourth embodiment and shows the axial cross section of the primary compression mechanism portion 20a at the rotational angle θ, at which the refrigerant pressure of the primary compression space Va_OUT reaches the discharge pressure.

### Other Embodiments

Although the representative embodiments of the present disclosure have been described above, the present disclosure should not be limited to the above-described embodiments. For example, various modifications can be made as follows.

In each of the above embodiments, there is described the example, in which the compressor 1 of the present disclosure is applied to the refrigeration cycle of the vehicle air conditioning apparatus. However, the present disclosure should not be limited to this application. The compressor 1 of the present disclosure can be used as any of various compressors, which respectively compress one of various types of fluids.

In each of the above embodiments, there is described the example, in which the drive force transmission mechanism that transmits the rotational drive force from the cylinder 21 to each rotor 22a, 22b has the structure that is equivalent to the pin and hole type self-rotation limiting mechanism. However, the present disclosure should not be limited to this structure. For example, a structure, which is similar to a self-rotation limiting mechanism of an Oldham ring type, may be used.

In each of the above embodiments, there is described the example, in which the compression mechanism 20 includes the primary compression mechanism portion 20a and the secondary compression mechanism portion 20b. However, the present disclosure should not be limited to this structure. The compression mechanism 20 may include a single compression mechanism portion or may include three or more compression mechanism portions.

In each of the above embodiments, there is used the electric motor 30 that includes the stator 31, which is the stationary member and is placed on the radially outer side of the cylinder 21 that functions as the rotating member (rotor) of the electric motor 30. However, the type of electric motor 30 should not be limited to this type. For example, the rotating member (rotor) of the electric motor 30 and the cylinder 21 may be formed separately from each other and may be configured such that the rotational drive force of the rotating member (rotor) of the electric motor 30 is transmitted to the cylinder 21. In this case, the compressor 1 may be configured such that the electric motor 30 and the compression mechanism 20 are placed one after another in the axial direction of the rotational central axis C1 of the cylinder 21.

In each of the above embodiments, there is described the example, in which the compressor 1 is formed as the electric compressor. However, the present disclosure should not be limited to this. The compressor 1 may be configured to be driven by a rotational drive force that is outputted from an internal combustion engine.

The constituent element(s) of each of the above embodiments is/are not necessarily essential unless it is specifically stated that the constituent element(s) is/are essential in the above embodiment, or unless the constituent elements) is/are obviously essential in principle.

Furthermore, in each of the above embodiments, in the case where the number of the constituent element(s), the value, the amount, the range, and/or the like is specified, the present disclosure is not necessarily limited to the number of the constituent element(s), the value, the amount, and/or the like specified in the embodiment unless the number of the constituent element(s), the value, the amount, and/or the like is indicated as indispensable or is obviously indispensable in view of the principle of the present disclosure.

Furthermore, in each of the above embodiments, in the case where the shape of the constituent element(s) and/or the positional relationship of the constituent element(s) are specified, the present disclosure is not necessarily limited to the shape of the constituent element(s) and/or the positional relationship of the constituent element(s) unless the embodiment specifically states that the shape of the constituent element(s) and/or the positional relationship of the constituent element(s) is/are necessary or is/are obviously essential in principle.

### CONCLUSION

According to a first aspect, which is indicated at some or all of the above embodiments, the rotary cylinder type compressor is configured such that the contact stress, which is exerted at the adjoining portion between the outer peripheral surface of the rotor and the inner peripheral surface of the cylinder, is increased when the pressure of the fluid in the compression space is increased.

Furthermore, according to a second aspect, in the rotor of the rotary cylinder type compressor, the central axis of the outer peripheral surface of the rotor is placed eccentrically relative to the central axis of the inner peripheral surface of the rotor such that the contact stress, which is exerted at the adjoining portion, is maximized in the range of rotational angle, throughout which the pressure of the fluid in the compression space becomes equal to or larger than the reference pressure.

With the above structure, in which the central axis of the outer peripheral surface of the rotor and the central axis of the inner peripheral surface of the rotor are eccentric to each other, the contact stress, which is exerted at the adjoining portion between the outer peripheral surface of the rotor and the inner peripheral surface of the cylinder, can be changed at the time of rotating the cylinder without a need for adding an additional member.

Furthermore, in this structure, the central axis of the outer peripheral surface of each rotor placed in the inside of the cylinder is placed eccentrically relative to the eccentric axis that is the central axis of the inner peripheral surface of the rotor. According to this, it is possible to limit the unstable weight balance of the rotatable constituent element of the compression mechanism, which is configured to rotate.

Furthermore, according to a third aspect, the protrusion, which protrudes toward the inner peripheral surface of the cylinder, is formed at the part of the outer peripheral surface of the rotor of the rotary cylinder type compressor that contacts the inner peripheral surface of the cylinder in the range of rotational angle, throughout which the pressure of the fluid in the compression space is equal to or larger than the reference pressure. By forming the protrusion, which protrudes toward the inner peripheral surface of the cylinder, at the outer peripheral surface of the rotor, the contact stress, which is exerted at the adjoining portion between the outer peripheral surface of the rotor and the inner peripheral surface of the cylinder at the time of rotating the cylinder, can be changed.

Furthermore, according to a fourth aspect, the protrusion, which protrudes toward the outer peripheral surface of the rotor, is formed at the part of the inner peripheral surface of the cylinder that contacts the outer peripheral surface of the rotor in the range of rotational angle, throughout which the pressure of the fluid in the compression space is equal to or larger than the predetermined reference pressure. By forming the protrusion, which protrudes toward the inner peripheral surface of the rotor, at the inner peripheral surface of the cylinder, the contact stress, which is exerted at the adjoining portion between the outer peripheral surface of the rotor and the inner peripheral surface of the cylinder at the time of rotating the cylinder, can be changed.

According to a fifth aspect, which is indicated at some or all of the above embodiments, the rotary cylinder type compressor is configured such that when the pressure of the fluid in the compression space is increased, the size of the minimum gap between the outer peripheral surface of the rotor and the inner peripheral surface of the cylinder, is reduced.

Furthermore, according to a sixth aspect, in the rotor of the rotary cylinder type compressor, the central axis of the outer peripheral surface of the rotor is placed eccentrically relative to the central axis of the inner peripheral surface of the rotor such that the size of the minimum gap is minimized in the range of rotational angle, throughout which the pressure of the fluid in the compression space becomes equal to or larger than the reference pressure.

With the above structure, in which the central axis of the outer peripheral surface of the rotor and the central axis of the inner peripheral surface of the rotor are eccentric to each other, the size of the minimum gap between the outer peripheral surface of the rotor and the inner peripheral surface of the cylinder can be changed at the time of rotating the cylinder without a need for adding an additional member.

Furthermore, in this structure, the central axis of the outer peripheral surface of each rotor placed in the inside of the cylinder is placed eccentrically relative to the eccentric axis that is the central axis of the inner peripheral surface of the rotor. According to this structure, it is possible to limit the unstable weight balance of the rotatable constituent element of the compression mechanism, which is configured to rotate.

Furthermore, according to a seventh aspect, the protrusion, which protrudes toward the inner peripheral surface of the cylinder, is formed at the part of the outer peripheral surface of the rotor that is most closely placed relative to the inner peripheral surface of the cylinder in the range of rotational angle, throughout which the pressure of the fluid in the compression space is equal to or larger than the reference pressure. By forming the protrusion, which protrudes toward the inner peripheral surface of the cylinder, at the outer peripheral surface of the rotor, the size of the minimum gap between the outer peripheral surface of the rotor and the inner peripheral surface of the cylinder at the time of rotating the cylinder can be changed.

Furthermore, according to an eighth aspect, the protrusion, which protrudes toward the outer peripheral surface of the rotor, is formed at the part of the inner peripheral surface of the cylinder that is most closely placed relative to the outer peripheral surface of the rotor in the range of rotational angle, throughout which the pressure of the fluid in the compression space is equal to or larger than the reference pressure. By forming the protrusion, which protrudes toward the inner peripheral surface of the rotor, at the inner peripheral surface of the cylinder, the size of the minimum gap between the outer peripheral surface of the rotor and the inner peripheral surface of the cylinder at the time of rotating the cylinder can be changed.

Furthermore, according to a ninth aspect, the rotary cylinder type compressor includes: the side plate that is placed at the end part of the cylinder in the axial direction of the rotational central axis and has the discharge hole, which discharges the fluid compressed in the compression space; and the discharge valve that opens the discharge hole when the pressure of the fluid in the compression space becomes larger than the predetermined discharge pressure. The reference pressure is the discharge pressure.

In the case where the reference pressure is the discharge pressure of the fluid, when the pressure difference between the compression space and the suction space becomes the largest, the contact stress, which is exerted at the contact portion between the outer peripheral surface of the rotor and the inner peripheral surface of the cylinder, can be increased, or the size of the minimum gap can be reduced. Therefore, it is possible to effectively limit the leakage of the fluid from the compression space to the suction space.

Furthermore, according to a tenth aspect, the rotary cylinder type compressor includes the shaft that is placed on the inner side of the rotor to rotatably support the rotor and has the supply passage, which supplies the fluid to the suction space. The communication passage, which communicates between the suction space and the supply passage, is formed at the rotor.

With this structure that uses the shaft as the supply passage of the fluid, the number of the components of the compressor and the size of the compressor can be limited in comparison to the case where the supply passage of the fluid is formed by another member.

1. A rotary cylinder type compressor comprising:
a housing that forms an outer shell:
a cylinder that is shaped into a cylindrical tubular form and is rotatably placed in an inside of the housing;
a rotor that is shaped into a cylindrical tubular form and is placed in an inside of the cylinder, wherein the rotor is rotatable about an eccentric axis that is eccentric to a rotational central axis of the cylinder by a rotational drive force of the cylinder; and
a partition member that partitions a working chamber formed between an outer peripheral surface of the rotor and an inner peripheral surface of the cylinder into a suction space, which suctions fluid, and a compression space, which compresses the fluid, wherein:
the rotor is provided as one of at least one rotor in the inside of the cylinder; and
the rotor and the cylinder are configured such that when a pressure of the fluid in the compression space is equal to or larger than a predetermined reference pressure, a contact stress, which is exerted at an adjoining portion between the outer peripheral surface of the rotor and the inner peripheral surface of the cylinder, is increased in comparison to a case where the pressure of the fluid in the compression space is smaller than the predetermined reference pressure.

2. The rotary cylinder type compressor according to claim 1, wherein a central axis of the outer peripheral surface of the rotor is placed eccentrically relative to a central axis of an inner peripheral surface of the rotor such that the contact stress, which is exerted at the adjoining portion between the outer peripheral surface of the rotor and the inner peripheral surface of the cylinder, is maximized in a range of rotational angle, throughout which the pressure of the fluid in the compression space is equal to or larger than the predetermined reference pressure.

3. The rotary cylinder type compressor according to claim 1, wherein a protrusion, which protrudes toward the inner peripheral surface of the cylinder, is formed at a part of the outer peripheral surface of the rotor that contacts the inner peripheral surface of the cylinder in a range of rotational angle, throughout which the pressure of the fluid in the compression space is equal to or larger than the predetermined reference pressure.

4. The rotary cylinder type compressor according to claim 1, wherein a protrusion, which protrudes toward the outer peripheral surface of the rotor, is formed at a part of the inner peripheral surface of the cylinder that contacts the outer peripheral surface of the rotor in a range of rotational angle, throughout which the pressure of the fluid in the compression space is equal to or larger than the predetermined reference pressure.

5. A rotary cylinder type compressor comprising:
a housing that forms an outer shell:
a cylinder that is shaped into a cylindrical tubular form and is rotatably placed in an inside of the housing;
a rotor that is shaped into a cylindrical tubular form and is placed in an inside of the cylinder, wherein the rotor is rotatable about an eccentric axis that is eccentric to a rotational central axis of the cylinder by a rotational drive force of the cylinder; and
a partition member that partitions a working chamber formed between an outer peripheral surface of the rotor and an inner peripheral surface of the cylinder into a suction space, which suctions fluid, and a compression space, which compresses the fluid, wherein:
the rotor is provided as one of at least one rotor in the inside of the cylinder; and
the rotor and the cylinder are configured such that when a pressure of the fluid in the compression space is equal to or larger than a predetermined reference pressure, a size of a minimum gap, which is smallest among gaps formed between the outer peripheral surface of the rotor and the inner peripheral surface of the cylinder, is reduced in comparison to a case where the pressure of the fluid in the compression space is smaller than the predetermined reference pressure.

6. The rotary cylinder type compressor according to claim 5, wherein a central axis of the outer peripheral surface of the rotor is placed eccentrically relative to a central axis of an inner peripheral surface of the rotor such that the size of the minimum gap is minimized in a range of rotational angle, throughout which the pressure of the fluid in the compression space is equal to or larger than the predetermined reference pressure.

7. The rotary cylinder type compressor according to claim 5, wherein a protrusion, which protrudes toward the inner peripheral surface of the cylinder, is formed at a part of the outer peripheral surface of the rotor that is most closely placed relative to the inner peripheral surface of the cylinder in a range of rotational angle, throughout which the pressure of the fluid in the compression space is equal to or larger than the predetermined reference pressure.

8. The rotary cylinder type compressor according to claim 5, wherein a protrusion, which protrudes toward the outer peripheral surface of the rotor, is formed at a part of the inner peripheral surface of the cylinder that is most closely placed relative to the outer peripheral surface of the rotor in a range of rotational angle, throughout which the pressure of the fluid in the compression space is equal to or larger than the predetermined reference pressure.

9. The rotary cylinder type compressor according to claim 1, comprising:
a side plate that is placed at an end part of the cylinder in an axial direction of the rotational central axis and has a discharge hole, which discharges the fluid compressed in the compression space; and
a discharge valve that opens the discharge hole when the pressure of the fluid in the compression space becomes larger than a predetermined discharge pressure, wherein the predetermined reference pressure is the predetermined discharge pressure.

10. The rotary cylinder type compressor according to claim 1, comprising a shaft that is placed on an inner side of the rotor to rotatably support the rotor and has a supply passage, which supplies the fluid to the suction space, wherein a communication passage, which communicates between the suction space and the supply passage, is formed at the rotor.

11. The rotary cylinder type compressor according to claim 5, comprising:
a side plate that is placed at an end part of the cylinder in an axial direction of the rotational central axis and has a discharge hole, which discharges the fluid compressed in the compression space; and
a discharge valve that opens the discharge hole when the pressure of the fluid in the compression space becomes larger than a predetermined discharge pressure, wherein the predetermined reference pressure is the predetermined discharge pressure.

12. The rotary cylinder type compressor according to claim 5, comprising a shaft that is placed on an inner side of the rotor to rotatably support the rotor and has a supply passage, which supplies the fluid to the suction space, wherein a communication passage, which communicates between the suction space and the supply passage, is formed at the rotor.
